(19) United States
(12) Patent Application Publication
(10) Pub. No.: US 2010/0076819 A1
(43) Pub. Date: Mar. 25, 2010

(54) System and Method for Distilling Data and Feedback From Customers to Identify Fashion Market Information

(75) Inventors: Louise J. Wannier, Pasadena, CA (US); James P. Lambert, Toluca Lake, CA (US); Mercedes DeLuca, Saratoga, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: myShape, Inc., Glendale, CA (US)

(21) Appl. No.: 12/566,605

(22) Filed: Sep. 24, 2009

Related U.S. Application Data
(60) Provisional application No. 61/100,237, filed on Sep. 25, 2008.

(51) Int. Cl. G06Q 30/00; G06Q 10/00; G06Q 50/00; G06F 15/16

(52) U.S. Cl. 705/10; 705/27; 709/204; 705/14.45

(57) ABSTRACT

A system and method is described herein for pulling information from numerous areas from manufacturers to end users to generate a total market map of the creation, use, and disposition of all products in a market. The system allows a customer to look at items, and suggest or request modifications from a manufacturer. This system may use known data, such as body measurements and body shape, to determine which products may meet the needs of a large subset of consumers. This also includes gathering profile information about users, such as fashion style and lifestyle preferences, shopping and spending habits, site browsing and usage history, and other demographic and psychographic data to discover market segments and the types of items most likely to be desired or purchased by consumers in each segment.

### CROSS-REFERENCE TO RELATED APPLICATIONS

This application claims benefit under 35 USC §119(e) of U.S. Provisional Patent Application No. 61/100,237 filed Sep. 25, 2008, which is herein incorporated by reference in its entirety for all purposes.

The present disclosure may be related to the following commonly assigned applications/patents:
U.S. Pat. No. 7,398,133 entitled “Matching the Fit of Individual Garments to Individual Consumers” issued to Wannier et al. (hereinafter “Wannier I”);
U.S. patent application Ser. No. 11/697,688 filed Apr. 6, 2007, entitled “Computer System for Rule-Based Clothing Matching and Filtering Considering Fit Rules and Fashion Rules” in the name of Wannier et al. (hereinafter “Wannier II”), published as U.S. Patent Publication 2007/0198120 published Aug. 23, 2007;
U.S. patent application Ser. No. 12/433,830 filed Apr. 30, 2009, entitled “System and Method for Networking Shops Online and Offline” in the name of Wannier et al. (hereinafter “Wannier III”);
U.S. patent application Ser. No. 12/494,242 filed Jun. 29, 2009, entitled “System and Method for Networking Shops Online and Offline” in the name of Wannier et al. (hereinafter “Wannier IV”);
U.S. patent application Ser. No. 12/494,244 filed Jun. 29, 2009, entitled “System and Method for Networking Shops Online and Offline” in the name of Wannier et al. (hereinafter “Wannier V”); and
U.S. patent application Ser. No. 12/510,198 filed Jul. 27, 2009, entitled A Distributed Matching System for Comparing Garment Information and Buyer Information Embedded in Object Metadata at Distributed Computing Locations Offline” in the name of Wannier et al. (hereinafter “Wannier VI”).
U.S. patent application Ser. No. 12/545,336 filed Aug. 21, 2009, entitled “System and Method To Identify and Visually Distinguish Personally Relevant Items” in the name of Wannier et al. (hereinafter “Wannier VII”).

The respective disclosures of these applications/patents are incorporated herein by reference in their entirety for all purposes.

### FIELD OF THE INVENTION

The present invention relates to computer systems, which can be local, centralized or distributed, for providing consumer access to databases of clothing items and in particular to computer shopping systems that programmatically match clothing items with individual consumers' data, possibly including searching, sorting, ranking and filtering database items providing a feedback mechanism between consumers and vendors/designers to distill consumer data to find market opportunities in disparities between what consumers have available and what consumers will buy.

### BACKGROUND OF THE INVENTION

In the field of online shopping, it is known to use an individual's measurements, shape, profile, etc. to filter through a listing of items for sale, such as garments and accessories, to show the individual only those items that fit and/or flatter based on some determination made from the items' measurements, shape, profiles, etc. and the individual's measurements, shape, profile, etc. Thus, the individual can be provided with a “personal shop” showing only the matching items that are personally relevant to the individual. Of course, the same process can be used for someone else shopping for the individual if that individual's parameters are available to the presentation and processing system that generates the views for the personal shop. Such personal shops are described in, for example, Wannier I, Wannier II, and Wannier III.

It is also known to use a multi-partner shopping system to provide a “personal mall”, to use a networked system to embed shops on multiple sites, to allow the assemblage of outfits from clothing items culled from across networked sources, to provide an online closet, to integrate shops with social networks, to provide shared “shop-together” experiences, to offer apparel subscriptions, to integrate vendor and buyer information using metadata, and to identify and visually distinguish personally relevant items. Systems that perform one or more of these features might be present in a system developed by myShape, assignee of the present application, and which might be shown in Wannier I, Wannier II, Wannier III, Wannier IV, Wannier V, Wannier VI and/or Wannier VII.

In today's clothing and accessories business, very few feedback mechanisms exist beyond sales numbers. So it is a hit and miss business, often resulting in good and bad cycles. The customer has only one realistic way of feeding back, by either buying the product or not. While consumer surveys are possible, these are not always reliable because, for example, not every opts to provide survey data and the characteristics of the volunteers and the nonvolunteers might skew the results. Also, in surveys people often say one thing, then act differently, as they give little or no thought to surveys in general. There is an almost infinite multiplicity of customer tastes and equally as many different schools of design. Similarly, detailed information about any particular item of clothing, such as dimensions, styling, construction, quantities, etc., is usually sequestered in vendors' proprietary data silos. Thus the collection of market information in the fashion world can be difficult, particularly because data is so splintered. Lack of comprehensive market information makes product planning difficult and can leave entire segments of the market unseen and therefore unserved or underserved.

Improved systems are needed.

### BRIEF SUMMARY OF THE INVENTION

A system and method is described herein for pulling information from numerous areas from manufacturers to end users to generate a total market map of the creation, use, and disposition of all products in a market. The system allows a customer to look at items, and suggest or request modifications from a manufacturer. This system may use known data, such as body measurements and body shape, to determine which products may meet the needs of a large subset of consumers. This also includes gathering profile information about users, such as fashion style and lifestyle preferences, shopping and spending habits, site browsing and usage history, and other demographic and psychographic data to discover market segments and the types of items most likely to be desired or purchased by consumers in each segment.

Furthermore, embodiments may calculate differentials between such market segment needs and actual product availabilities in order to identify untapped market opportunities. The system may inform clothing designers, makers and vendors of those opportunities so that they can best determine which items to manufacture. The system may also make recommendations for meeting identified market needs, for example recommending adjustments to: styling by shape, size or quality, pattern measurements, styling attributes or pricing. Thus, the system can drive new product designs either from the vendors to the users or from the users to the vendors, depending on from which end the most initiative springs.

### BRIEF DESCRIPTION OF THE DRAWINGS

FIG. 1 is an illustration of a clothes shopping system, in accordance with described embodiments.

FIG. 2 is a simplified block diagram of a consumer-garment matching method, in accordance with described embodiments.

FIG. 3 is a simplified block diagram of a definition process, in accordance with described embodiments.

FIGS. 4A-D illustrate height and length measurement techniques, in accordance with described embodiments.

FIGS. 5A-B are simplified block diagrams of a categorization process, in accordance with described embodiments; FIG. 5A shows a consumer recording process and FIG. 5B shows a garment recording process.

FIG. 6 is a simplified block diagram of a match assessment process, in accordance with described embodiments.

FIGS. 7-13 include flowcharts illustrating a match assessment process for a fitted dress, in accordance with described embodiments.

FIG. 14 is an illustration of example output from a match assessment process, in accordance with described embodiments.

FIG. 15 is an illustration of a garment display interface, in accordance with described embodiments.

FIGS. 16-18 are illustrations of clothes shopping systems, in accordance with described embodiments.

FIG. 19 is a block diagram of a linked lists creation process in accordance with described embodiments.

FIG. 20 is an illustration of a clothes shopping system, in accordance with described embodiments.

FIG. 21 is a block diagram of an outfit presentation process in accordance with described embodiments.

FIGS. 22-24 are block diagrams of a body shape, consumer, and garment categorization processes, in accordance with embodiments of the invention.

FIG. 25 is an illustration of a match system, in accordance with embodiments of the invention.

FIG. 26 is an illustration of a clothes shopping system, in accordance with described embodiments.

FIG. 27 is a block diagram of a preferred fashion presentation process in accordance with described embodiments.

FIGS. 28-30 are block diagrams of a fashion product and accessory presentation and recommendation processes in accordance with described embodiments.

FIG. 31 is a block diagram of an altered garment presentation process in accordance with described embodiments.

FIG. 32 is a block diagram of a garment profiling process in accordance with described embodiments.

FIG. 33 is an illustration of a clothes shopping system, in accordance with described embodiments.

FIGS. 34-36 are block diagrams of a user shopping update process in accordance with described embodiments.

FIG. 37 illustrates metadata structure of a garment image and of a consumer image.

FIG. 38 illustrates an exemplary searching process

FIG. 39 illustrates an exemplary process for the metadata use of RFID tags.

FIG. 40 is an illustration of a clothes shopping system, in accordance with described embodiments.

FIG. 41 is a block diagram of a differentiated views creation process in accordance with described embodiments.

FIG. 42 is a block diagram of a differentiated views creation process in accordance with described embodiments.

FIG. 43 is an illustration of differentiated view techniques, in accordance with described embodiments.

FIG. 44 is a block diagram of a process to identify matching items in accordance with described embodiments.

FIG. 45 is an illustration of a market mapping system, in accordance with described embodiments.

FIG. 46 is a block diagram of a process to identify market segments and opportunities, in accordance with described embodiments.

These and other embodiments of the invention are described in further detail below.

### DETAILED DESCRIPTION

An improved online clothes shopping system is described herein, where a consumer is presented with a personalized online store that lists clothing items for sale that are most likely to fit and flatter that particular consumer and match that consumer's preferences for style and fit. The presented list of items is generated by a computerized garment-consumer matching method that matches the fit and fashion of individual clothing items to individual consumers. In embodiments of the system, a shopper is provided with a differentiated display of items, thereby allowing the user to discern which items match a “personal shop” criteria, among items that might not match that “personal shop” criteria. It should be understood that references to “shopper” include agents, friends, associates, family members, etc. who are shopping for the ultimate user/wearer/consumer of the items being shopped for. For example, where person A is shopping for a dress as a gift for person B, the personal shop profile that is being used by the computer to form displays, compute and interact with person A is actually the personal shop profile of person B. For brevity, this will not be repeated each time, but it should be understood that the appropriate personal shop profile is used at the appropriate time.

A system and method for pulling information from numerous areas from manufacturers to end users to generate a total market map of the creation, use, and disposition of all products in a market would be useful. A system that allows the customer to look at items, and suggest or request modifications from a manufacturer, that gathers profile information about users to discover market segments and needs, that calculates differentials between such market segment needs and actual product availability in order to identify market opportunities, would also be useful. For example, where a personal shop, personalized for a particular consumer, lacks items in a particular category, it would be useful to aggregate that information and provide it to vendors. For example, if there are many examples of consumers with body shape “Y” searching for slacks, but not having any slacks in their personal shop, a vendor ready to make slacks would want to know that there is a ready market waiting to be targeted.

In some embodiments, the systems described herein would inform clothing designers, makers and vendors of those opportunities and make recommendations for meeting those market needs, so that they can best determine which items to manufacture and sell. The system might pull information from numerous areas from manufacturers to end users to generate a total market map of the creation, use, and disposition of all products in a market would be useful. It would further allow the customer to look at items, and suggest or request modifications from a manufacturer, gathers profile information about users to discover market segments and needs, calculate differentials between such market segment needs and actual product availability in order to identify market opportunities, and/or inform clothing designers, makers and vendors of those opportunities and make recommendations for meeting those market needs, so that they can best determine which items to manufacture and sell.

According to aspects of the present invention, elements and embodiments can be provided in part by novel components, implemented in software, hardware and/or network protocols.

Clothing items are commonly thought to include garments (dresses, coats, pants, shirts, tops, bottoms, socks, shoes, bathing suits, capes, etc.), but might also include worn or carried items such as necklaces, watches, purses, hats, accessories, etc. In any of the following examples, sized and fitted garments are the items being shopped for, but it should be understood that unless otherwise indicated, the present invention may be used for shopping for other clothing items as well. As used herein, an outfit is a collection of two or more clothing items intended to be worn or used together.

In describing embodiments of the invention, female consumers and women's apparel will serve as examples. However, the invention is not intended to be limited to women's apparel as the invention may be used for various types of apparel including men's and children's apparel. Throughout this description the embodiments and examples shown should be considered as exemplary rather than limitations of the present invention.

In a matching process, garments and consumers are compared. For garments, the garment measurements, garment style/proportion and garment attributes (color, weave, fabric content, price, etc.) might be taken into account, while for the consumer, consumer measurements, consumer body proportion (such as shape code), and consumer fit and style and fashion preferences (how snug/loose, color, classic/contemporary/romantic, etc.), might be taken into account.

Fashion rules can be defined for various garment style(s) that suit a particular body proportion, both for garments and for outfits, including accessorizing. Fashion rules (programmatically defining fashion expertise) can be “overlaid” on the matches to recommend the best combinations that will fit and flatter. In this manner, a consumer might be presented with a large number of garments to choose from, but each would be more likely to be a “good choice”, while leaving out those garments that are less likely to fit or flatter. There could be a wide variety of garments and styles, etc., but organized as a personal store for that consumer.

### Clothes Shopping System

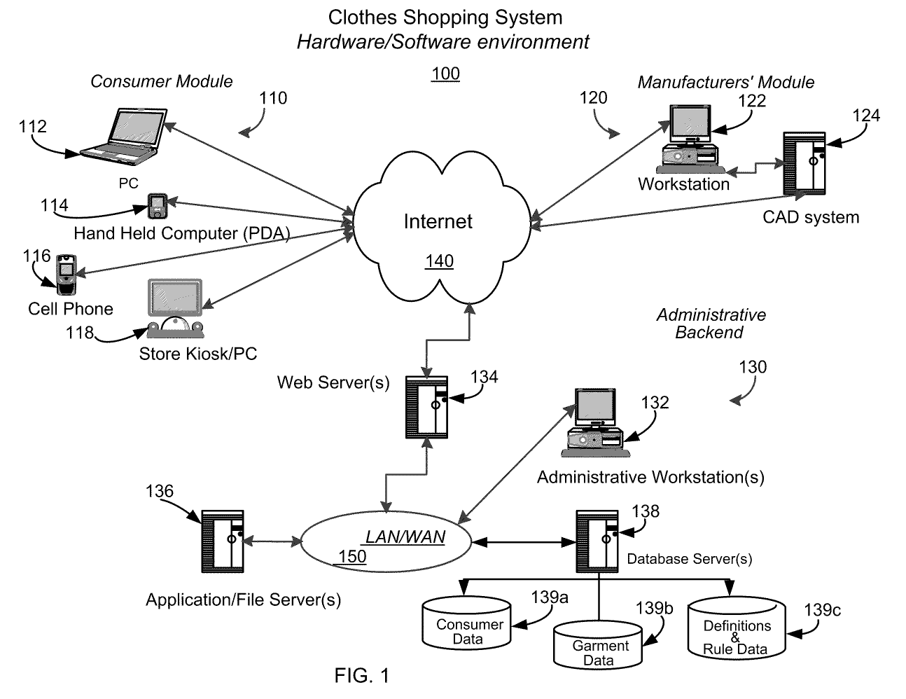

FIG. 1 is a high-level diagram depicting a clothes shopping system 100, which is a computer implementation of a consumer-garment matching method in accordance with one embodiment of the present invention. The clothes shopping system is a client-server system, i.e., an assemblage of hardware and software for data processing and distribution by way of networks, as those with ordinary skill in the art will appreciate. The system hardware may include, or be, a single or multiple computers, or a combination of multiple computing devices, including but not limited to: PCs, PDAs, cell phones, servers, firewalls, and routers.

As used herein, the term software involves any instructions that may be executed on a computer processor of any kind. The system software may be implemented in any computer language, and may be executed as compiled object code, assembly, or machine code, or a combination of these and others. The software may include one or more modules, files, programs, and combinations thereof. The software may be in the form of one or more applications and suites and may include low-level drivers, object code, and other lower level software.

The software may be stored on and executed from any local or remote machine-readable media, for example without limitation, magnetic media (e.g., hard disks, tape, floppy disks, card media), optical media (e.g., CD, DVD), flash memory products (e.g., memory stick, compact flash and others), Radio Frequency Identification tags (RFID), SmartCards™, and volatile and non-volatile silicon memory products (e.g., random access memory (RAM), programmable read-only memory (PROM), electronically erasable programmable read-only memory (EEPROM), and others), on paper (e.g., printed UPC barcodes). In some embodiments, the software is stored in smart textile material, embedded in intelligent clothing and/or wearable electronics.

Data transfer to the system and throughout its components may be achieved in a conventional fashion employing a standard suite of TCP/IP protocols, including but not limited to Hypertext Transfer Protocol (HTTP) and File Transfer Protocol (FTP). The eXtensible Markup Language (XML), an interchange format for the exchange of data across the Internet and between databases of different vendors and different operating systems, may be employed to facilitate data exchange and inter-process communication. Additional and fewer components, units, modules or other arrangement of software, hardware and data structures may be used to achieve the invention described herein. An example network is the Internet, but the invention is not so limited.

In one embodiment, a clothes shopping system 100 comprises three interconnecting components: a consumer module 110, a manufacturer module 120, and an administrative backend 130. These three components can all be operated over a network such as local and/or wide area networks (LAN/WAN) 150, and the Internet 140. In some embodiments, the clothes shopping system is present in a portable device that a shopper uses in a store that can interact with the items for sale in that store and/or a database of items that is usable by the shopper's device. In such cases, no networking might be needed at all.

The administrative backend 130 uses administrator workstations 132, web servers 134, file and application servers 136, and database servers 138. The backend houses the consumer-garment matching software, the consumer and garment record databases 139a-139b, definition & rules database 139c, and the online store website with all of its necessary ecommerce components, such as Webpage generators, order processing, tracking, shipping, billing, email and security. Administrator workstations allow for the management of the entire system and all of its parts, including the inputting and editing of data.

The manufacturer module 120 uses software/hardware that allows a manufacturer to input data into the garment records that represent the garments the manufacturer makes. For example, for each garment of a particular size or SKU, a manufacturer enters the garment's dimensional measurements and profile data into the manufacturer module. This data may be entered manually via a workstation 122 or automatically by interfacing with the manufacturer's own internal systems, such as CAD systems 124 and PLM (product lifetime management) systems, and/or pattern making systems. This inputted garment data might then be subjected to the garment categorization process 220, as described herein.

Additionally, the module may provide the manufacturer with computed output from the system, such as the shape codes of their various garments. The manufacturer may now employ the system's output in his manufacturing process; for example, to print shape code(s) on a garment's label or sales tag, or to electronically embed part or all of a garment's record in its RFID tag. In some embodiments, a shopper's device will signal when some item meets the “fit and flatter” requirement as determined by the consumer module or as determined by a remote system performing the matching process.

The consumer module 110 is typically accessed by consumers via personal computers at home, school or office 112. The consumer module 110 may also be accessed through cellular phones 116, PDAs 114 and other networked devices, such as kiosks 118 in retail stores at malls, shopping centers, etc. It is through the consumer module 110 that a consumer can input her measurements, preferences and profile data into her consumer record. This inputted consumer data might then be subjected to the consumer categorization process 220, as described herein. And importantly, the consumer module enables the consumer to shop and buy at her personalized online clothes store.

Data such as consumer and garment records, that normally are input via the consumer and manufacturer modules, might also be input and edited via the administrative backend 130.

### The Consumer-Garment Matching Method

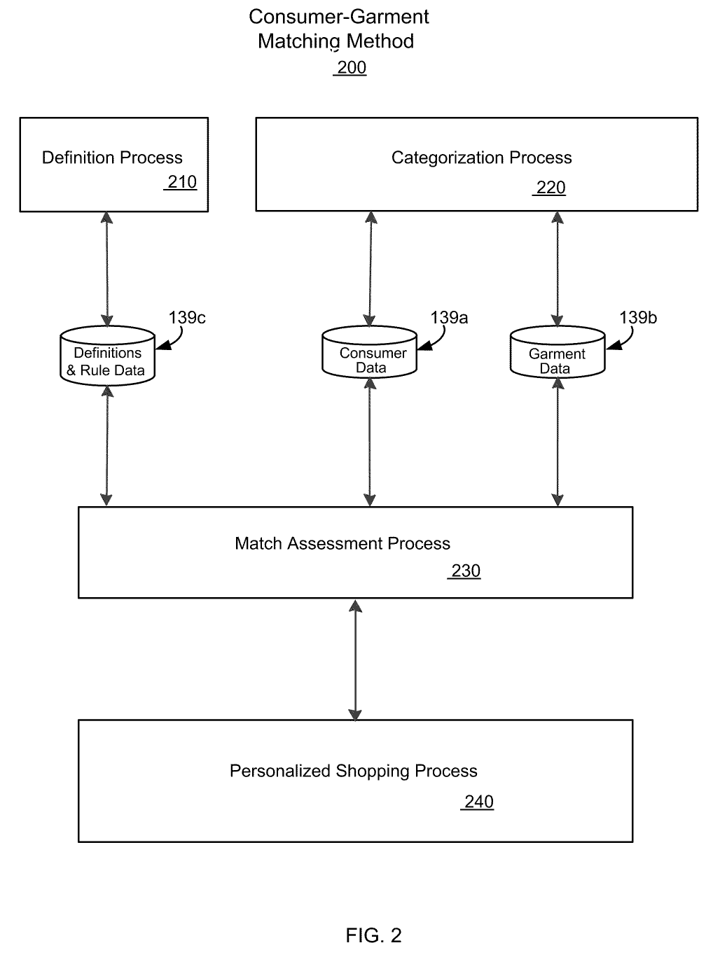

FIG. 2 is a simplified block-diagram depicting a consumer-garment matching method 200 and the data inputs, outputs and interdependence of its constituent processes: a definition process 210, a categorization process 220, a match assessment process 230, and a personalized shopping process 240, described herein.

### Definition Process

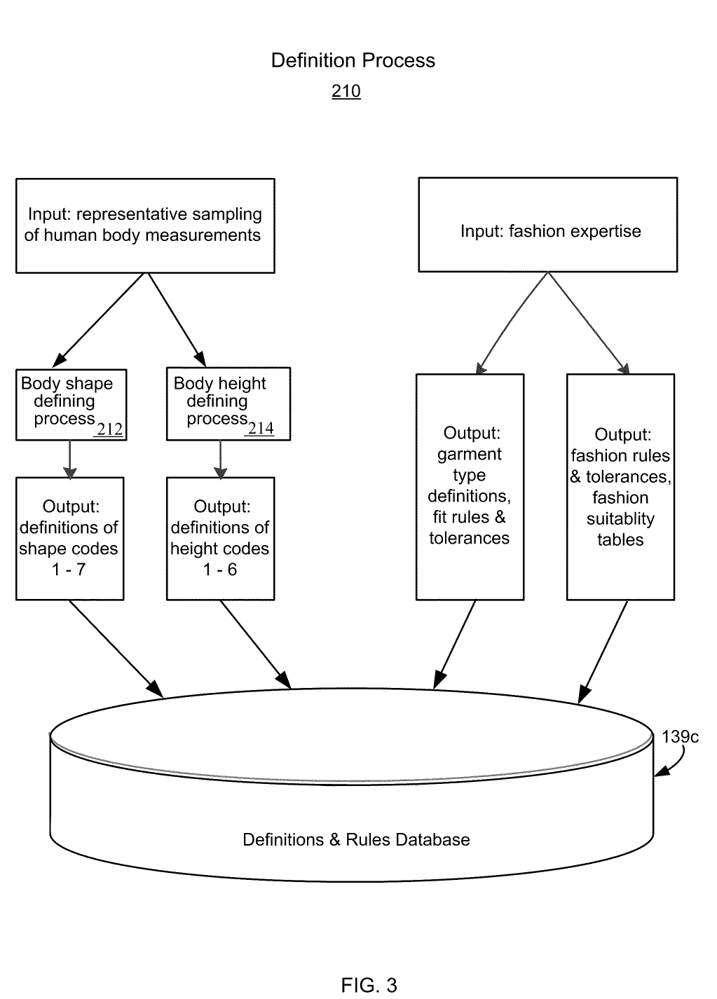

FIG. 3 depicts a definition process 210. The definition process defines a) human body shapes into a set of shapes (represented by shape codes 1 through 7 in this embodiment), b) human body heights into a set of heights (represented by height codes 1 through 6 in this embodiment), c) garment types (sixteen in this embodiment), d) fit rules, and e) fashion rules.

Prior to defining either human body shapes or human body heights, it is first necessary to determine a list of critical measurements of the human body. Table 1 lists twenty one such measurements as used in one embodiment of the present invention. Other embodiments may use more, fewer or different body measurements. A similar or identical set of measurements may also be used by the categorization process 220 when collecting body measurement data from any individual consumer via the consumer module 110. Note: The measurement reference numbers appearing in Table 1 will be subsequently used throughout this document to concisely write formulae. The lowercase “c” (for consumer) denotes these measurements are provided by the consumer, such as might result from personal manual measurements.

TABLE 1
Body Measurements

| Measurement Name | Meas. Ref. # |
|---|---|
| Shoulder Circumference | 1Cc |
| Bust Circumference | 2Cc |
| Waist Circumference | 3Cc |
| High Hip Circumference | 4Cc |
| Hip Circumference | 5Cc |
| Shoulder to Shoulder Front | 6Fc |
| Bust Front | 7Fc |
| Waist Front | 8Fc |
| High Hip Front | 9Fc |
| Hip Front | 10Fc |
| Top of Head Height | 11Hc |
| Shoulders Height | 12Hc |
| Bust Height | 13Hc |
| Waist Height | 14Hc |
| High Hips Height | 15Hc |
| Hips Height | 16Hc |
| Knee Height | 17Hc |
| Total Rise | 18Dc |
| Armhole Circumference | 19Dc |
| Inseam | 20Dc |
| Arm | 21Dc |

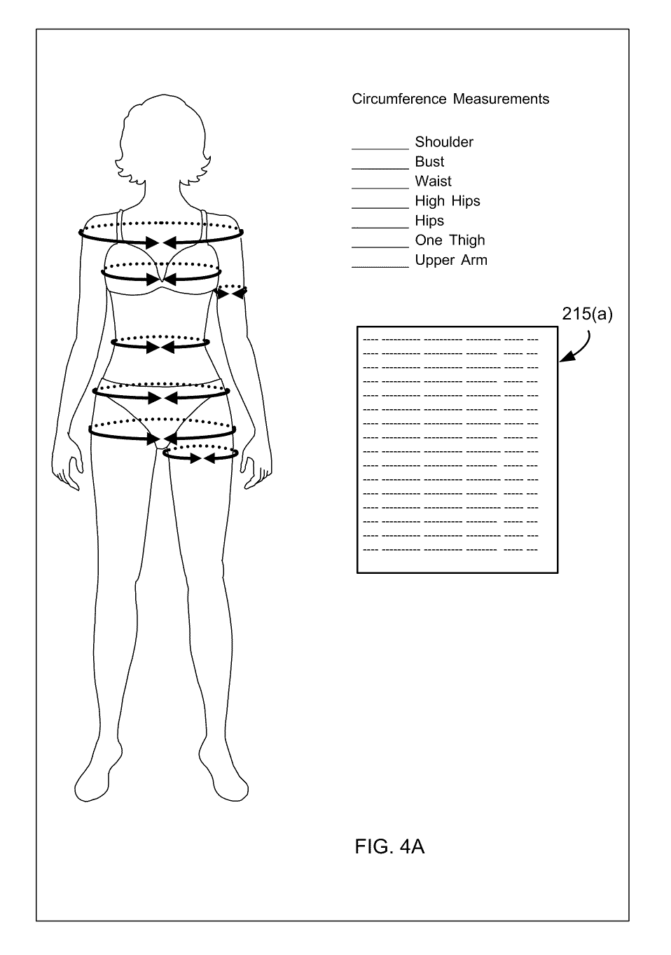

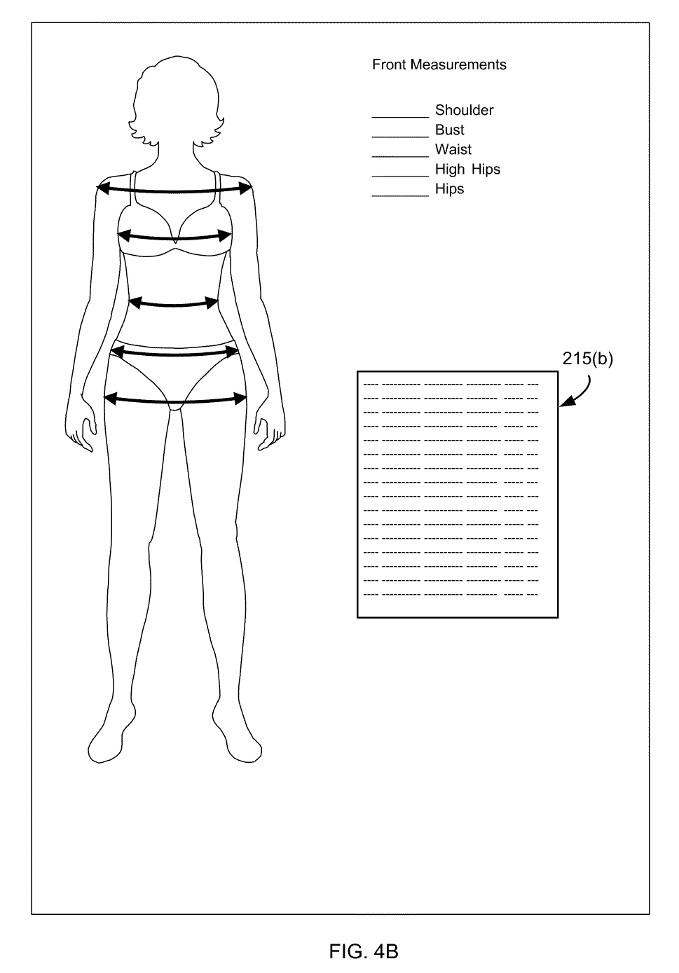

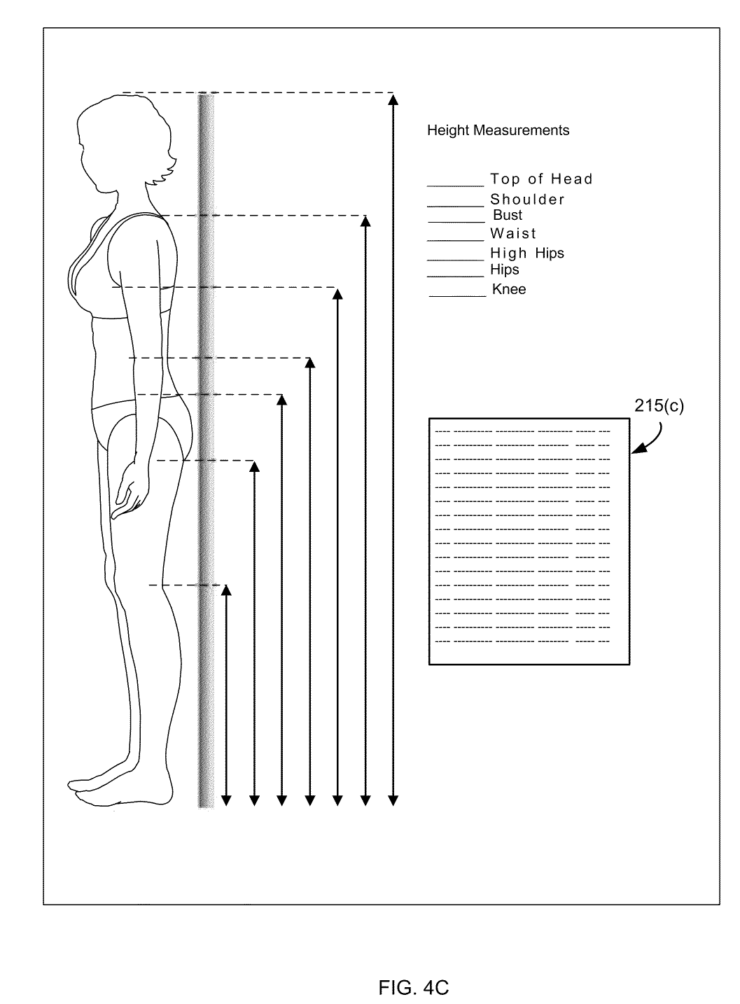

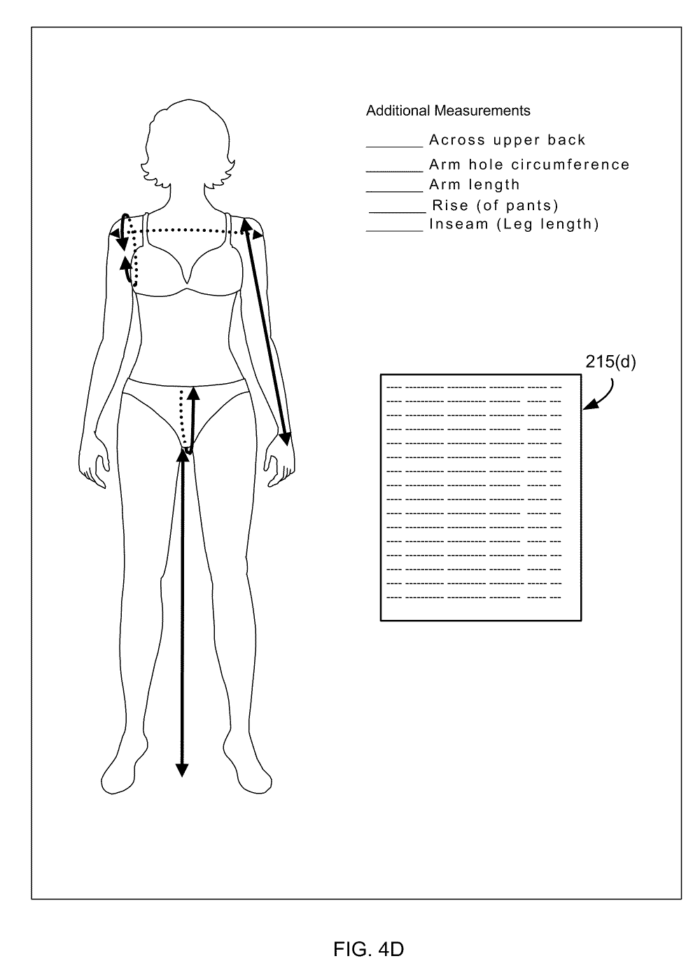

FIGS. 4A-4D depict the positions and techniques for acquiring body measurements to obtain consumer data shown in Table 1, as an example.

The displays of FIGS. 4A-4D might include instructions to the reader, as instruction blocks 215(a), 215(b), 215(c) and 215(d). Examples of instruction blocks are:

215(a) in FIG. 4A:
Measure the CIRCUMFERENCE of your body at various points.
Shoulders: Measure around shoulders, just below the shoulder joint, going outside your arms at the widest point.
Bust: Measure bust at fullest point and straight across back.
Waist: Measure around torso at your waistline.
High Hips Measure over top of hip bones, 2″-4″ below waist.
Hips: Measure at the fullest part, usually 7″-9″ from waist.
One Thigh: Measure at the fullest part of one thigh on one leg (your choice).
Upper Arm: Measure the circumference of the thickest part of your upper arm (that bicep muscle!).

215(b) in FIG. 4B:
Measure the FRONT OF YOU from the middle of one side to the middle of the other only. It helps if you are wearing lightweight, form fitting clothes with side seams to help locate the side of your body.
Front of Shoulders: Measure from mid point of upper arm just below the shoulder joint to the same point of the opposite side, crossing the front of your body.
Front of bust: Measure from as close to middle of one side of your body to the middle of the other crossing over the fullest part of your bust.
Front of Waist: Measure from middle of one side to the middle of the other at your waist.
Front of High Hips: Measure over top of hip bones, 2″-4″ below waist.
Front of Hips: Measure from the middle of one side to the middle of the other at the fullest part of your hips, usually 7″-9″ from waist.

215(c) in FIG. 4C:
Measure the HEIGHT of the following by taping or attaching a measuring tape to the bottom of a wall or doorway (floor—measurement zero) to measure the heights. A book, ruler or straight edge can help. This will give a vertical silhouette.
Top of head: Measure from the floor to the top of your head.
Should height: Measure from the floor to the top of your shoulder joint.
Bust height: Measure from the floor to the fullest point of your bust.
Waist Height Measure from the floor to your waistline.
High hip height: Measure from the floor to your high hip (your hip bone, usually 2″-4″ below your waist).
Hip height: Measure from the floor to the fullest point of your hips.
Knee height: Measure from the floor to the mid-point of your knee.

215(d) in FIG. 4D:
Almost done, just a few more!
Across upper back: Measure across your upper back from end of shoulder joint to end of shoulder joint. Or, for a shortcut, use a favorite jacket, measuring from shoulder seam to shoulder seam.
Arm hole circumference: Measure top of should under arm and back around to the top of the arm.
Arm length: Measure from the middle of the shoulder joint to the wrist joint, with slightly bent elbow.
Rise (of pants): Start at middle for your waist in back, pass tape measure between your legs and up to the middle of your waist in front. Do not pull tight on this measurement, and don't make it too loose. Keep comfort in mind and make sure you are measuring your body accurately. A shortcut is to measure your favorite pair of pants.
Inseam (leg length): Measure from the crotch to the floor on the inside of your leg. Or, for a shortcut, measure the inseam of your favorite pair of pants.
Human body shapes are defined by a body shape defining process 212. Similarly, the same sample body measurement data form the inputs of a body height defining process 214. Definitions of body shape codes and body height codes are stored in the definitions & rules database 139c as maintained by database server 138. Thus these body shape codes may then be assigned by the categorization process 220. A similar or identical set of measurements may be used by the categorization process 220 when collecting garment measurement data for any individual garment via the manufacturer module 120. A garment type definition table specifies the measurements, tolerances and order of calculation to be used by the measurement filter 232 during a match assessment 230. Garment type definitions together with their fit rules and tolerances are stored in a definitions & rules database 139c as maintained by database server 138. The Fashion rules, tolerances and fashion suitability tables are stored by the definition process 210 in a definitions & rules database 139c as maintained by database server 138.

### Categorization Process

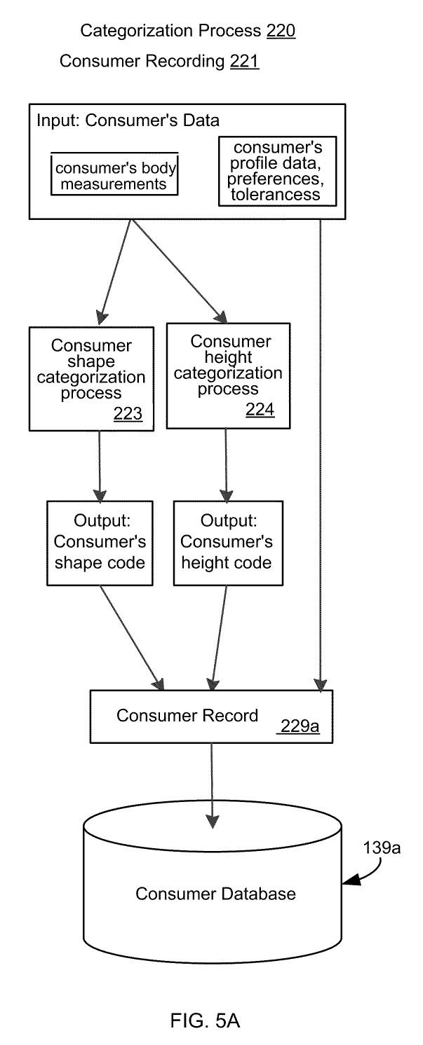

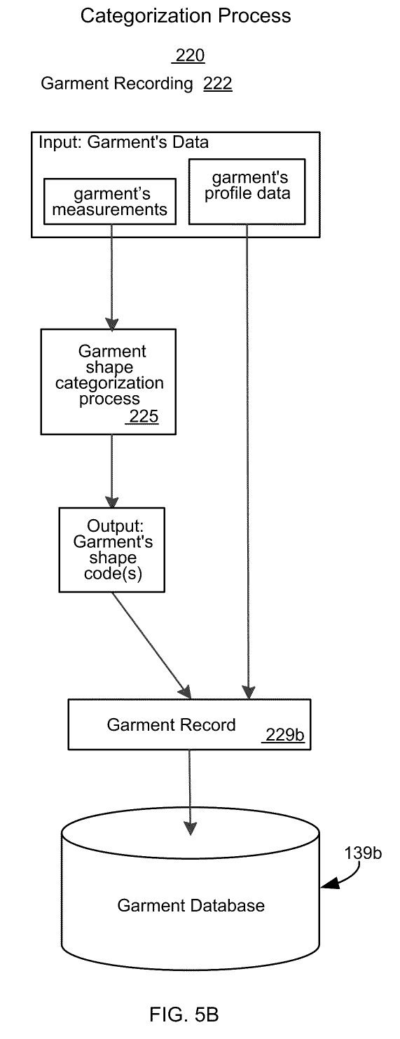

As embodied herein and depicted in FIGS. 5A-5B, a categorization process 220 has two sub-processes: consumer recording 221 (FIG. 5A) and garment recording 222 (FIG. 5B). A consumer record 229a is data describing an individual consumer. A garment record 229b is data describing an individual garment, including its measurements and profile, e.g., its color, fabric, tolerances, etc. The consumer records 229a are stored by the categorization process 220 in a consumer database 139a, while garment records 229b are stored in a garment database 139b. The consumer and garment databases are maintained by database server 138.

### Consumer Recording

An individual consumer's body measurements, such as those depicted in FIGS. 4A-4D, are input into a consumer shape categorization process 223. The resulting shape code is assigned to the consumer and stored in her record 229a. A consumer height categorization process 224 calculates a consumer's height code. The height categorization process is used to assign a height code to a consumer. The assigned height code can be stored in the consumer's record 229a.

### Garment Recording

The manufacturer module 120, described herein, supplies the garment measurements and profile data that form the inputs of the garment recording process 222. Referring again to FIGS. 5A-B, a garment's measurements are inputs to a garment shape categorization process 225. The resulting shape codes are assigned to the garment and stored in its garment record 229b. The consumer records 229a can be stored in a consumer database 139a, while garment records 229b can be stored in a garment database 139b. The consumer and garment databases can be maintained by database server 138.

### Match Assessment Process

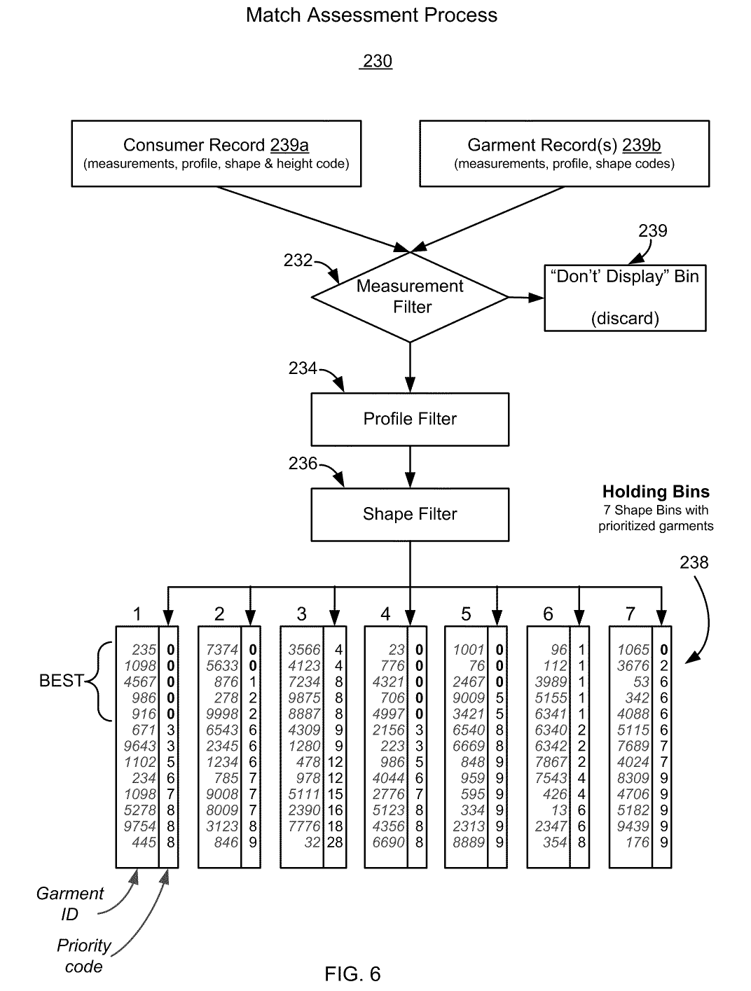

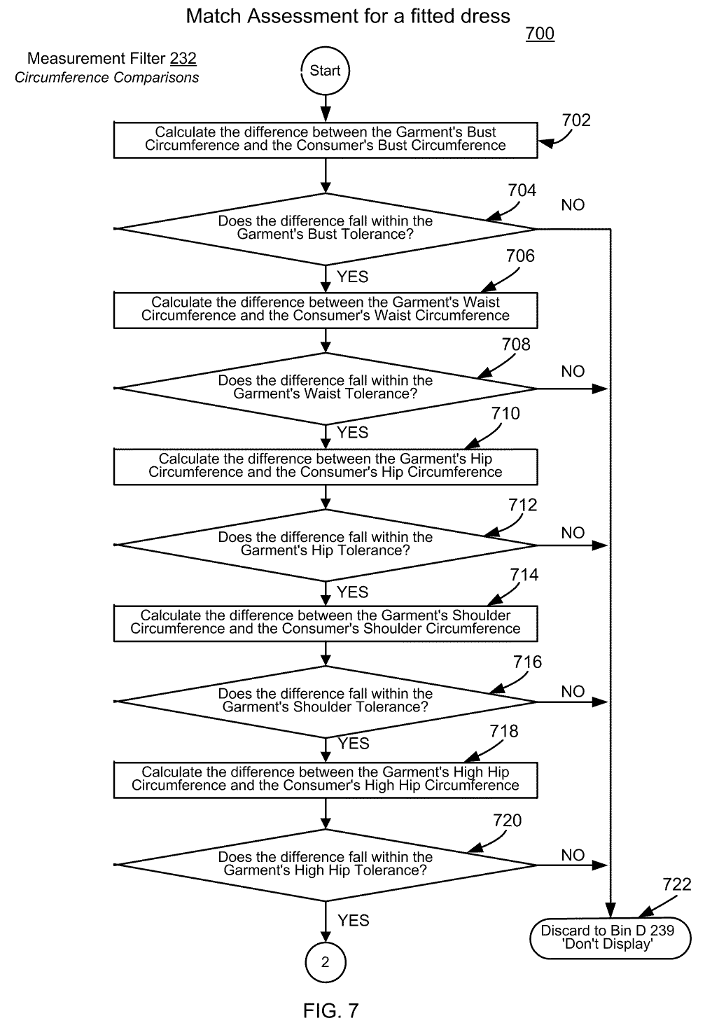

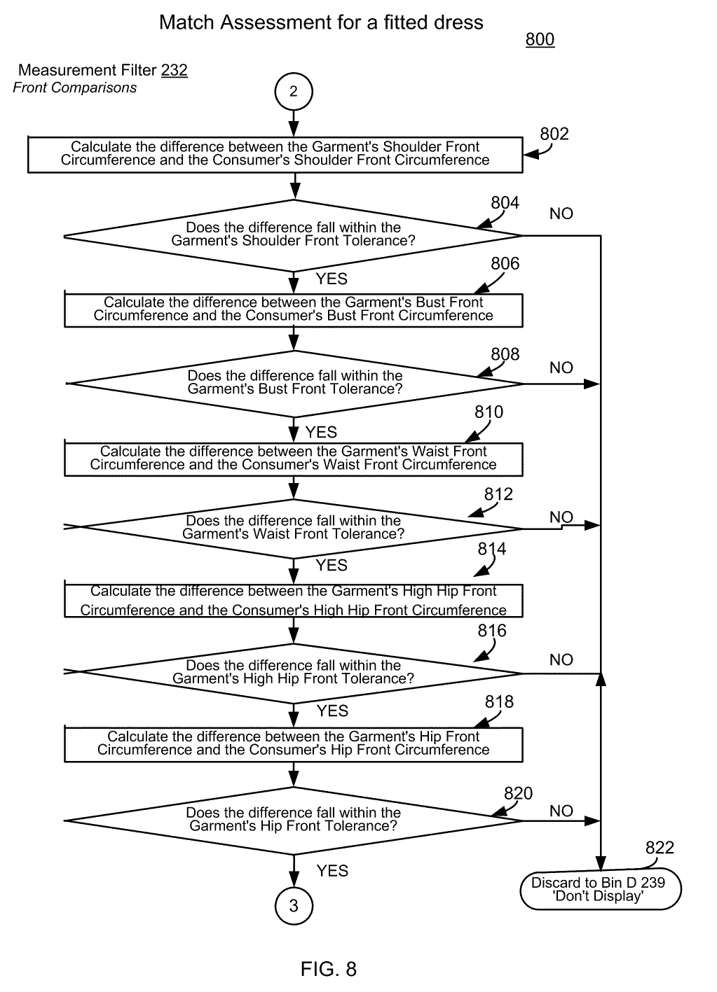

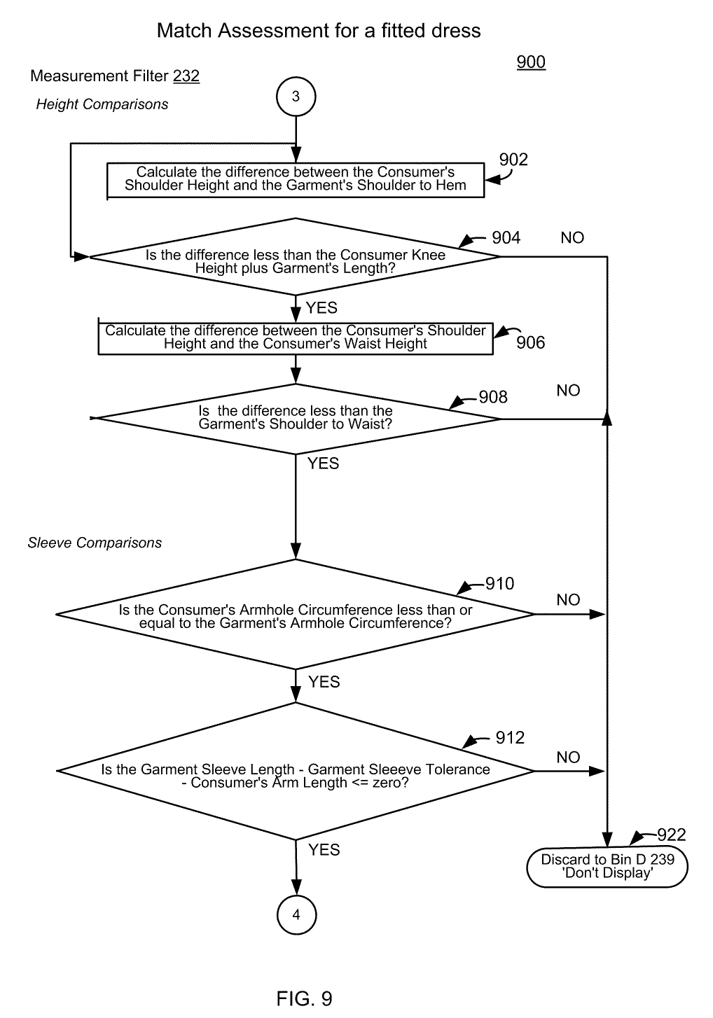

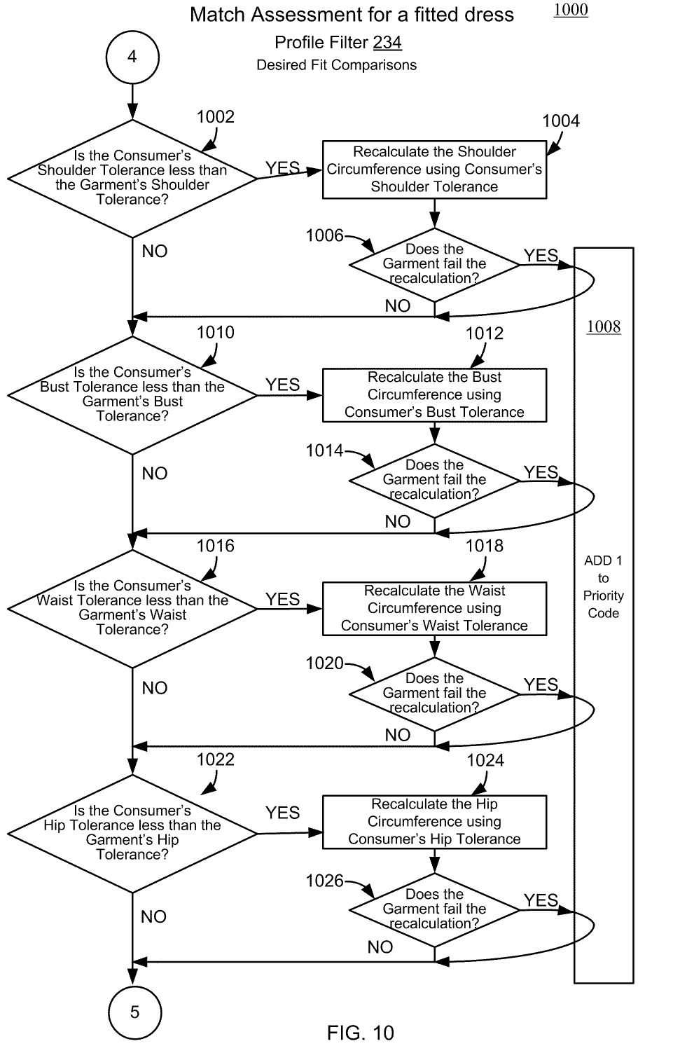

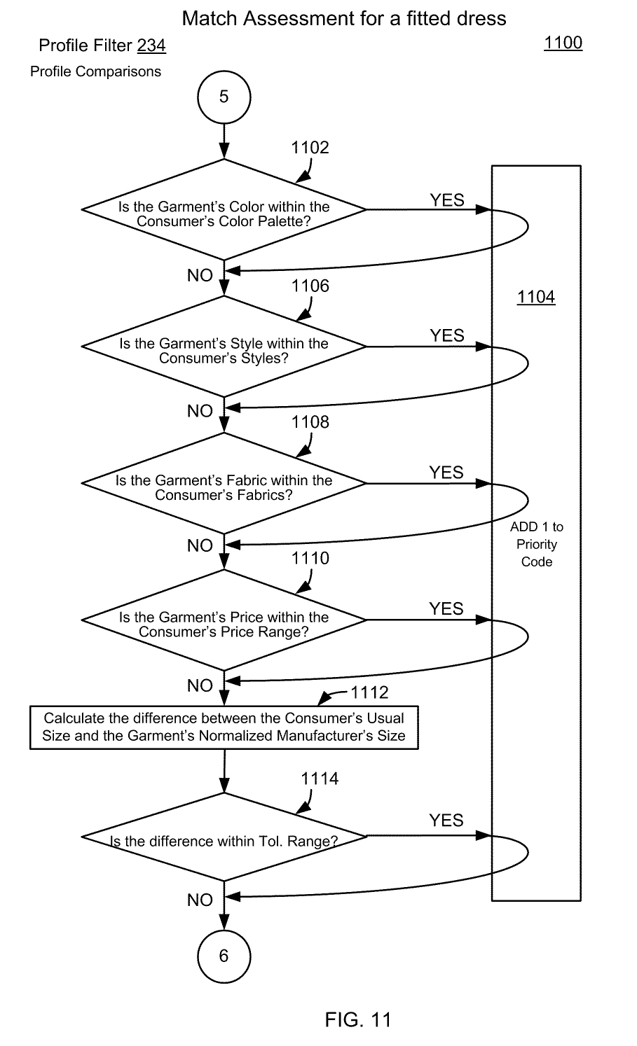

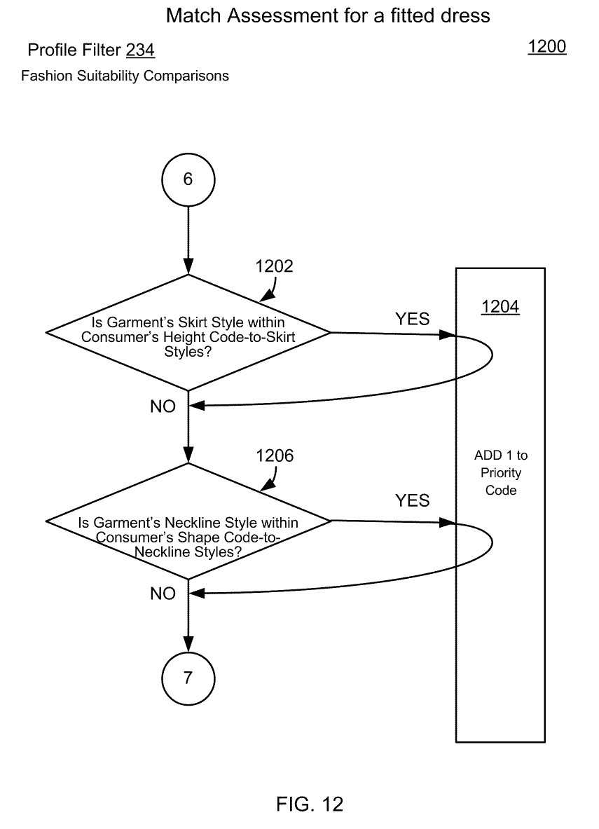

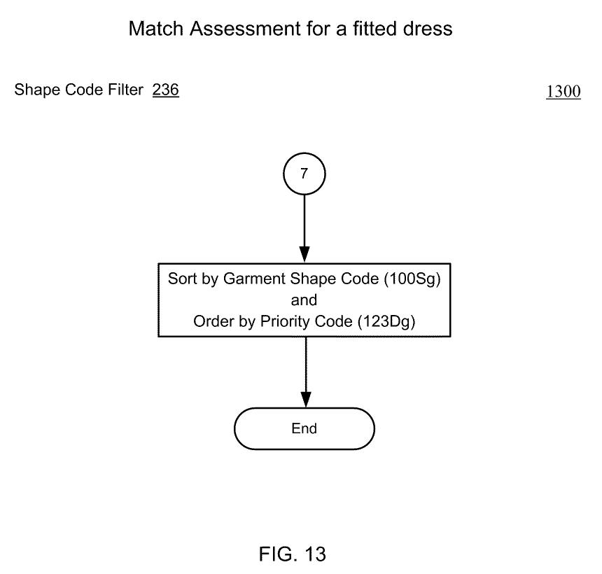

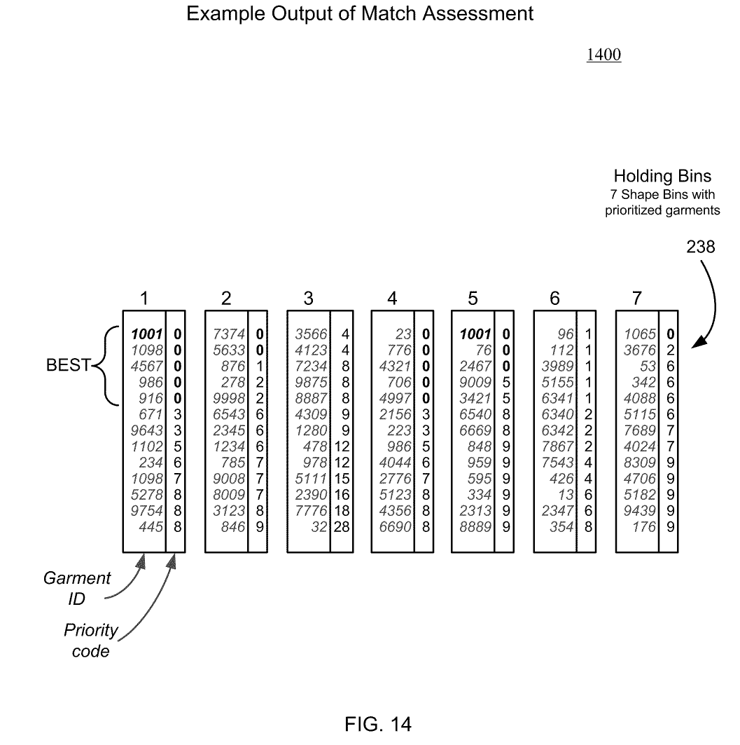

FIGS. 6-14 depict a match assessment process 230 and various elements thereof. The match assessment process treats both sewn clothing items and fashion accessories as garments. Thus it matches individual consumers with individual clothing items or individual accessories in the same manner and with equal efficacy. Further details of match assessment processes are taught in detail in Wannier I, II and/or III.

### Personalized Shopping Process

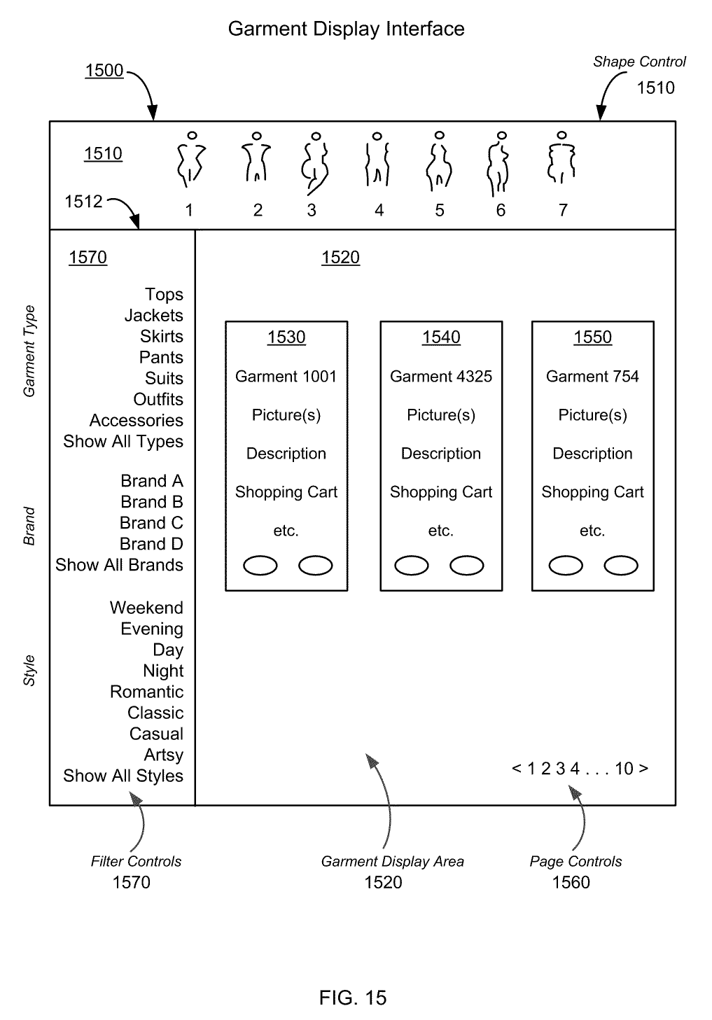

A personalized shopping process 240 presents a consumer with her personal online clothing store. In one embodiment, the consumer is presented with a personal store, which shows the customer garments, outfits and complementary accessories that match the customer's measurements, body shape, height code, personal preferences and fashion styling, that will fit her and flatter her as determined by the fashion suitability rules. In one embodiment, the results of a match assessment 230 of multiple garments and outfits may be displayed to the consumer using a graphical user interface (GUI) 1500 as depicted in FIG. 15. Further details of a personalized shopping process that might be used as the base for the present invention are taught in detail in Wannier I, II and/or III.

### Personal Mall

In addition to providing the consumer with a personalized store, elements of the systems described above can be expanded to cover a personal mall, wherein filtering is done as above, but over multiple online retail outlets. The particular retail outlets that are part of the system would depend on a number of criteria and the operator of the matching system might provide that access in exchange for commissions, as well as upselling, cross-marketing and providing other useful features for the consumer. An advantage to those retailers who join the personal mall and provide a virtual storefront is reduced return rates. With proper arrangement of the personal mall, each retail outlet can present its own brand and may be the shipper that ships the products directly to the consumer.

Among other teachings, a multi-partner shopping system is described that can be used for shopping for clothes and accessories, shoes, purses, and/or other products that include or embody notions of fashion and/or style. In one implementation, content is maintained on servers and served to browsers on request, with some content generated on the fly. The presentation of this material, collectively, by a server having access to the content is often referred to as a “website”, although the “location” of such a site is virtual and often in the minds of the users. Nonetheless, that shorthand is used herein and it should be understood that a website is content served by a physical computing system or a process running on a physical computing system. Likewise, when referring to operations that the “website” does or presents, it should be understood that those operations are performed by a processing device, processor, etc. executing instructions corresponding to the operations or perhaps specialized hardware, firmware or the like.

Online can refer to electronic communications and/or remote access of one computing system or device by another computing system or device, often those having client-server relationships. The access can be over a network of some sort or another. A common example used herein, but not intended to be limiting, is the Internet.

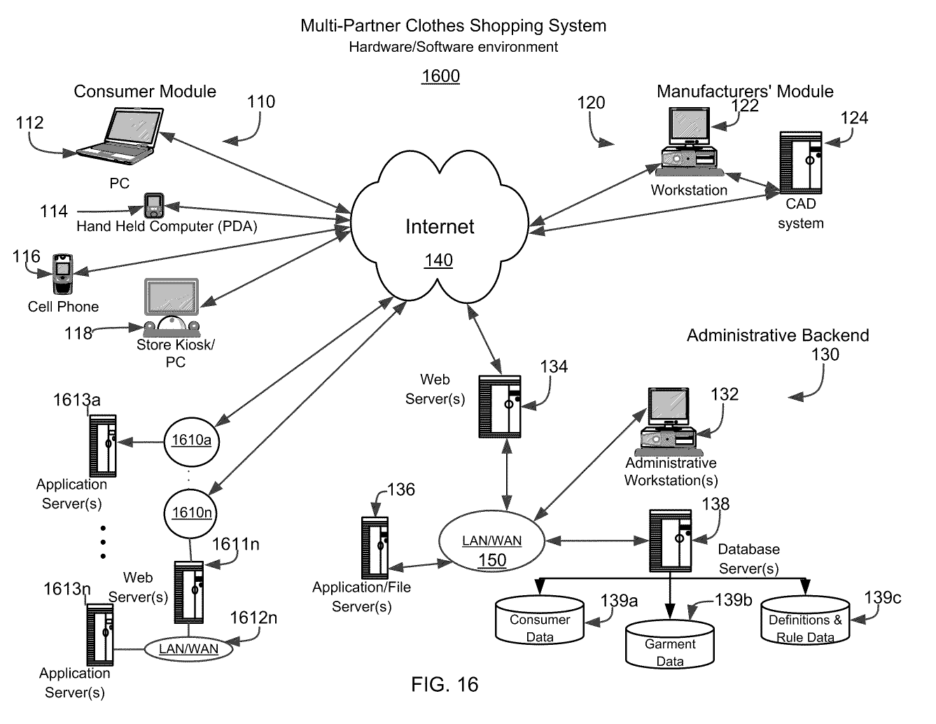

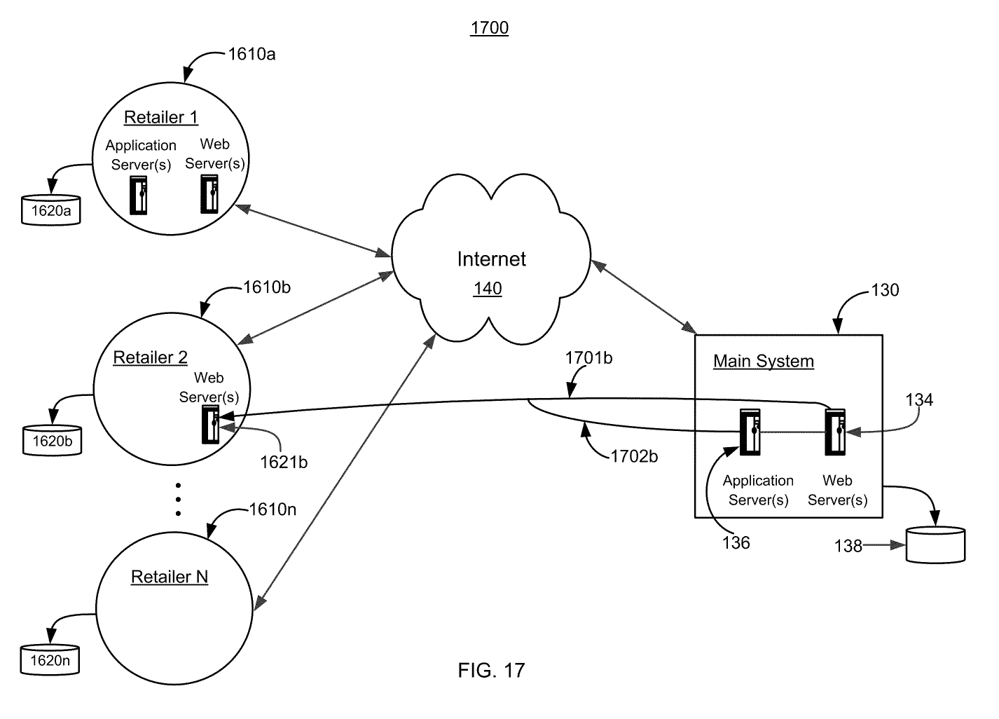

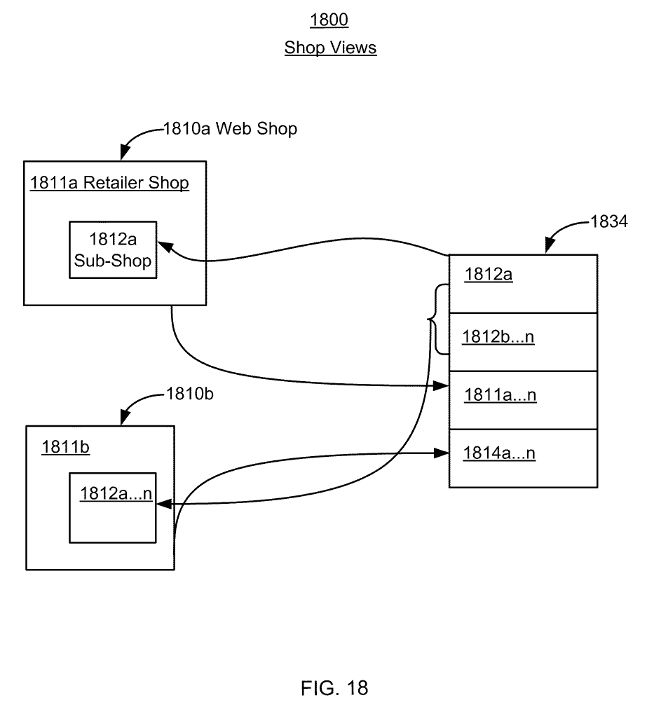

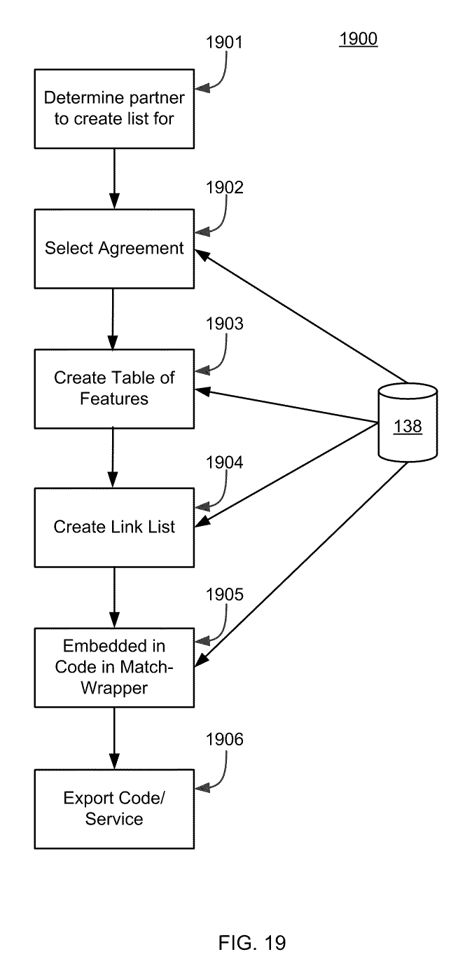

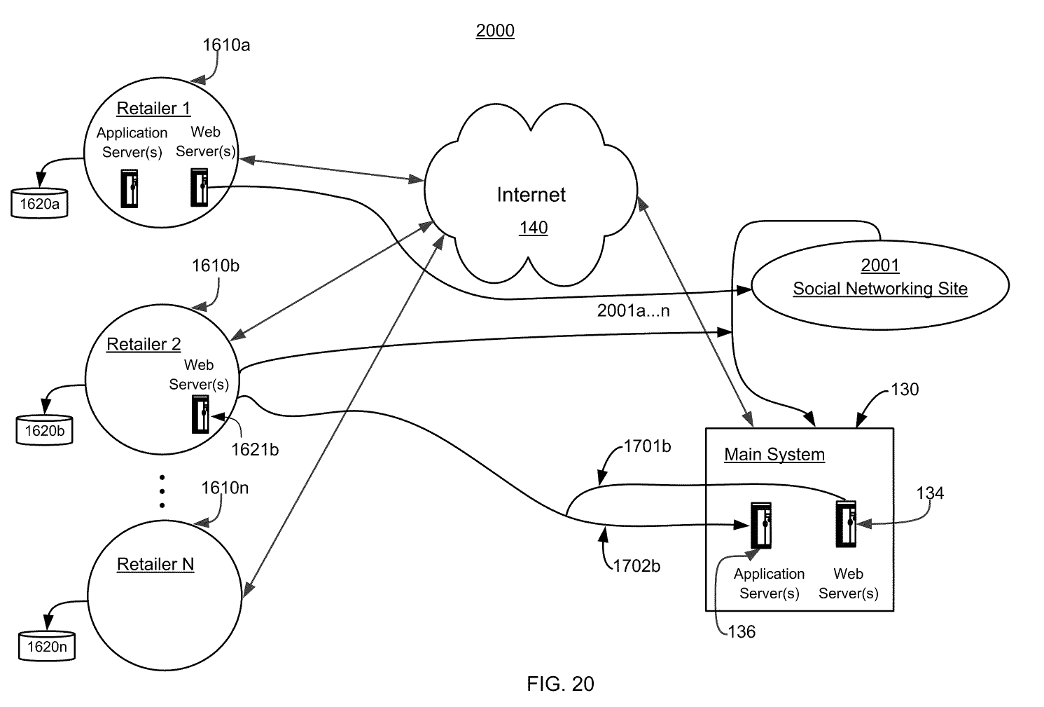

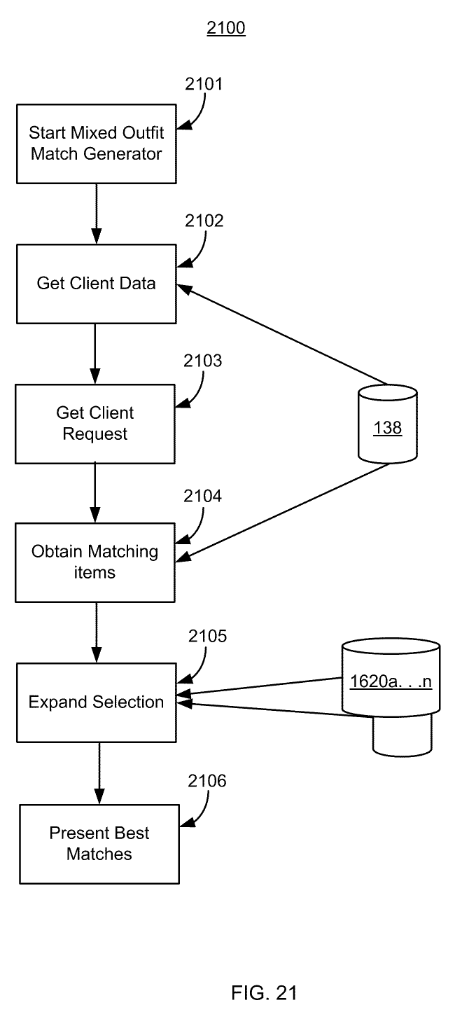

FIGS. 16-21 show an enhanced overview of a multi-partner clothes and accessories, shoes, purses, and all other products that include the notions of fashion and style, shopping system 1600. Further teachings along these lines are provided by Wannier III.

Using such a shopping system, several benefits are provided, such as a system and method for integrating embedded shops on multiple sites, linked to a virtual personal shopping channel where each person can instantly see within their personal shop the clothes and other fashion items that “match” a user's profile and fit and flatter within each node of the network. Those shops can be integrated with social networks and syndication of content for marketing products. The shopping system might generate product combinations from a plurality of inventories at a point of sale for a transaction and a system of soliciting interest in custom-made garments based on user indication, and in some cases including on-line closet representations of consumer-owned items.

The shopping system might allow for shopping of outfits or ensembles of items, allowing users to mix and match on any website or kiosk any part of such an outfit or ensemble, matching to other parts on other websites or items already owned by customer and/or known to the system.

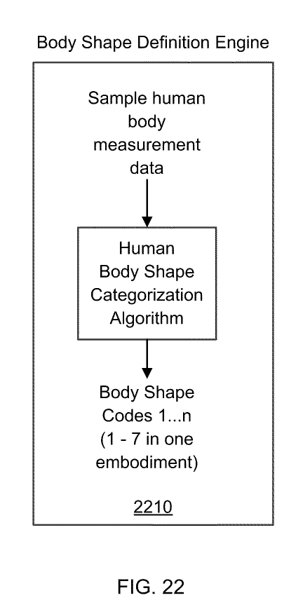

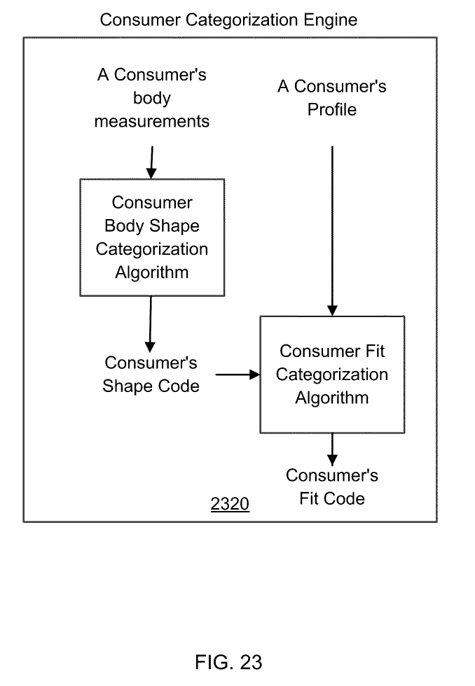

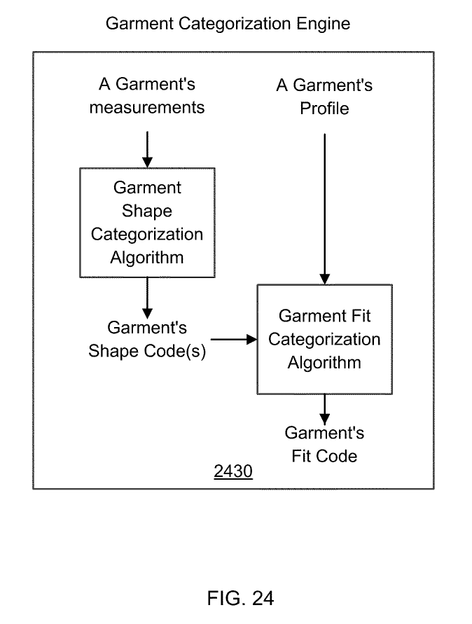

FIGS. 22-24 depict a categorization process 2205 that is described in greater detail in Wannier IV. Individual consumers can be categorized.

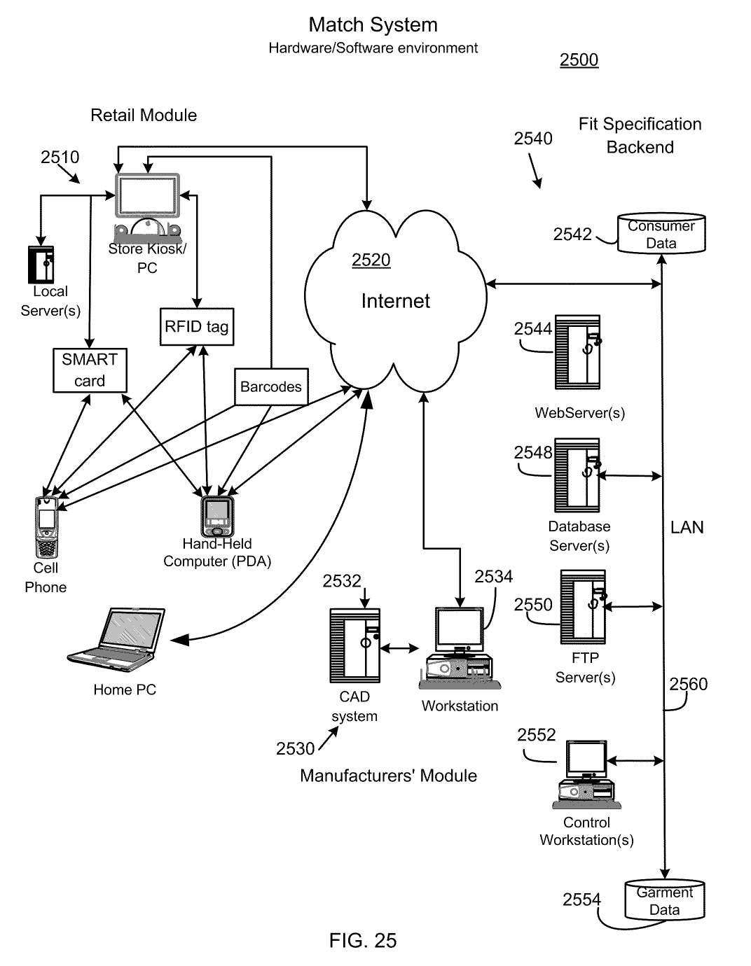

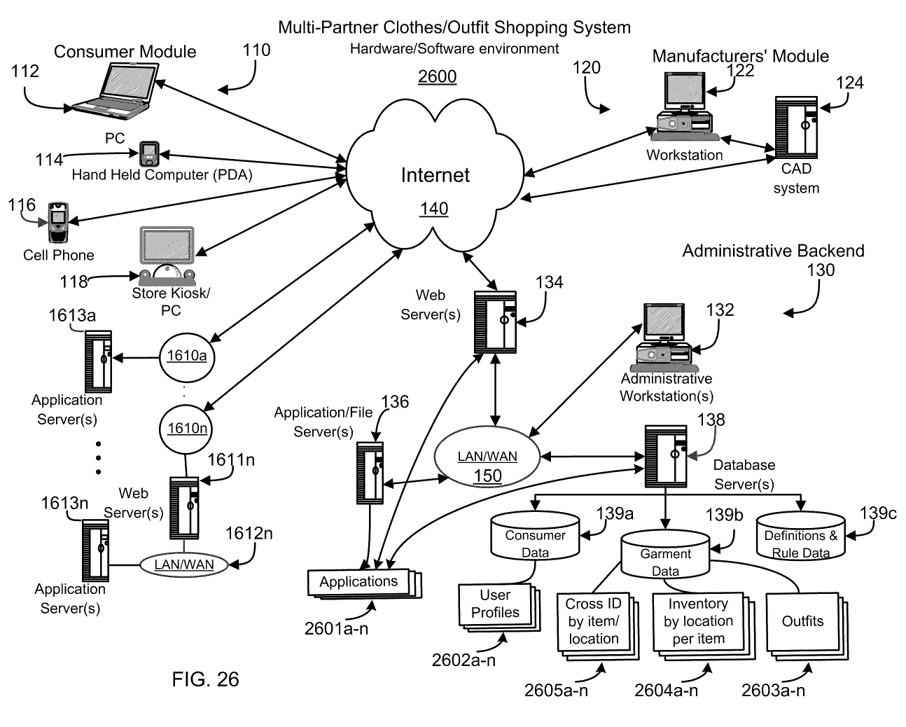

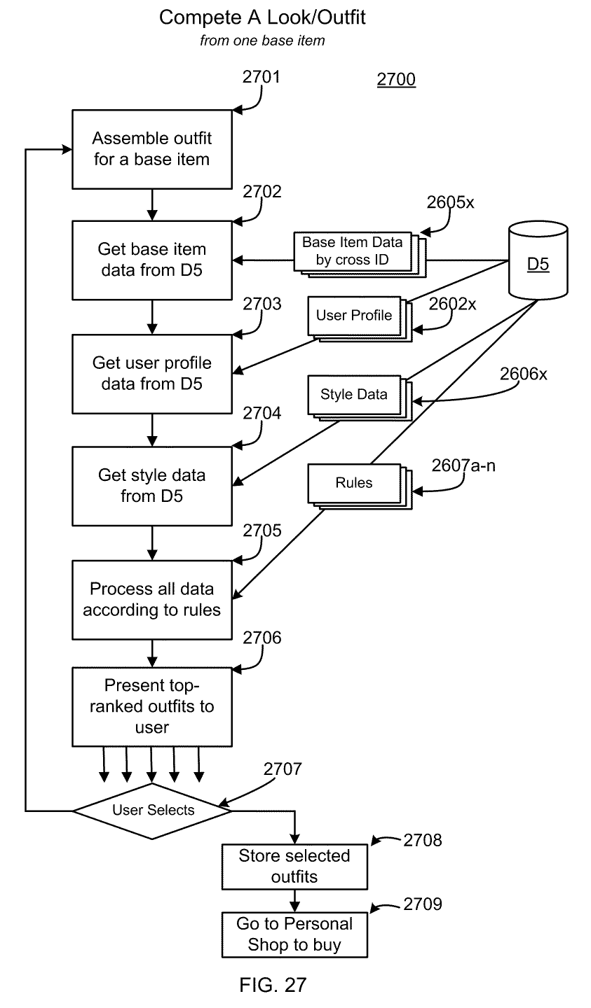

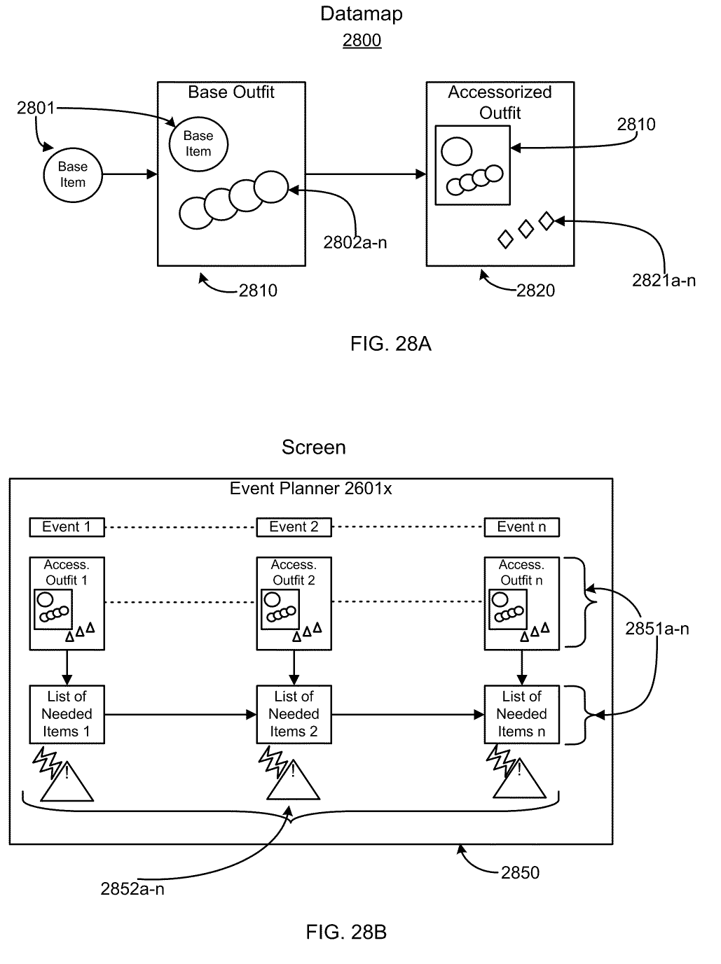

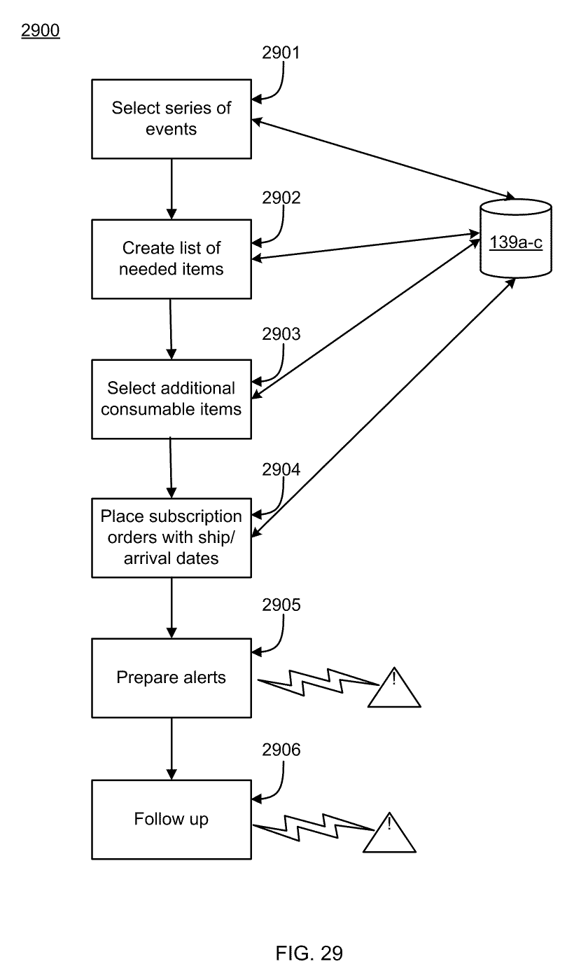

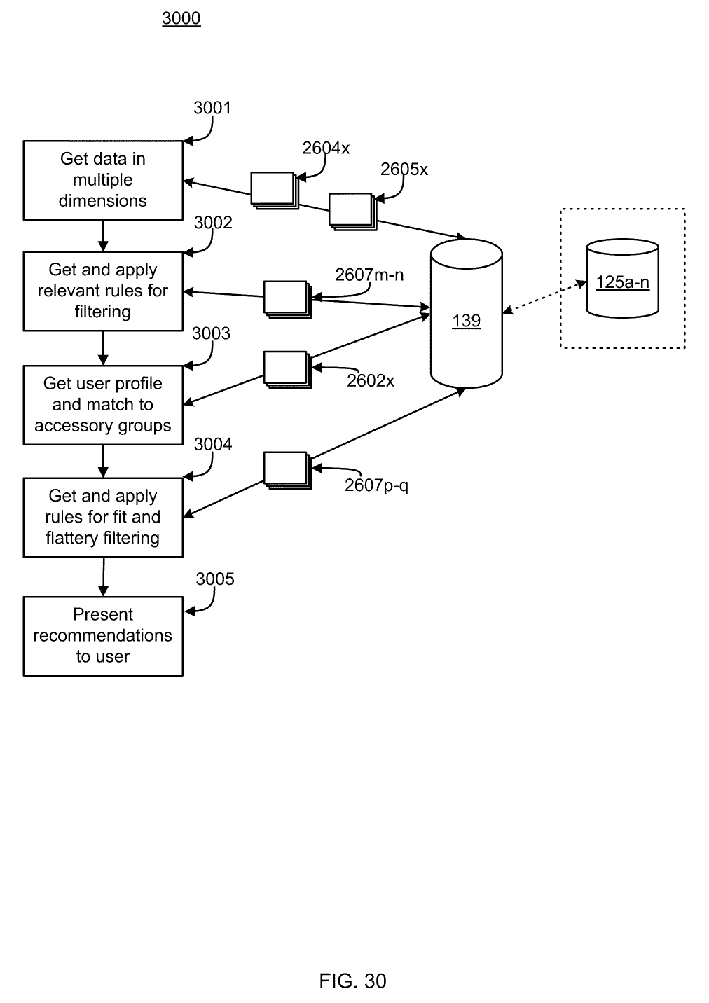

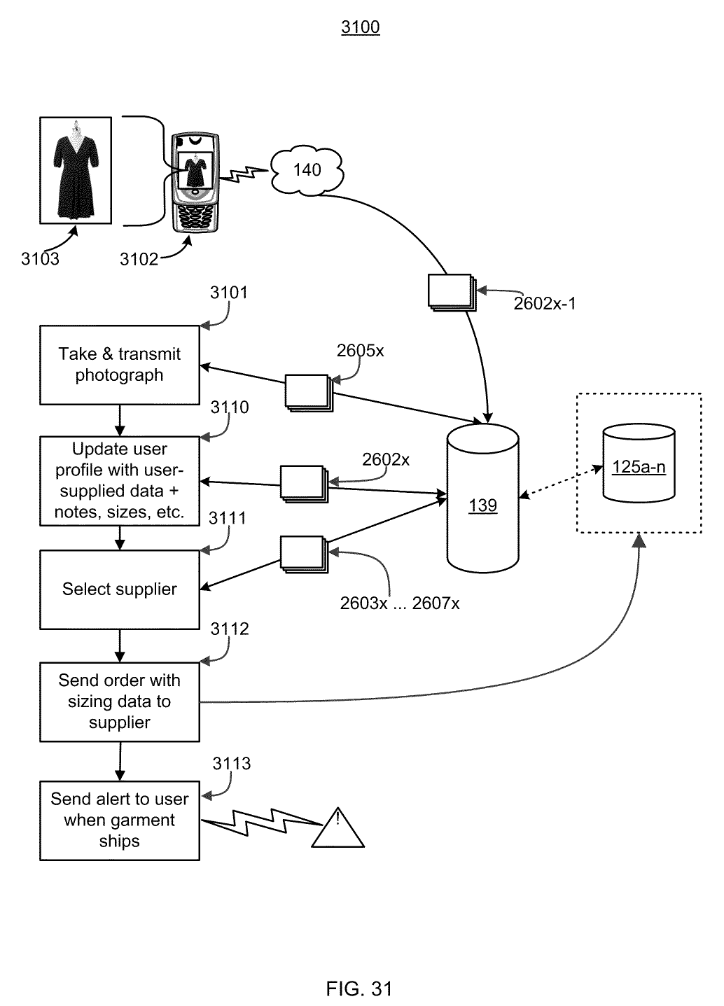

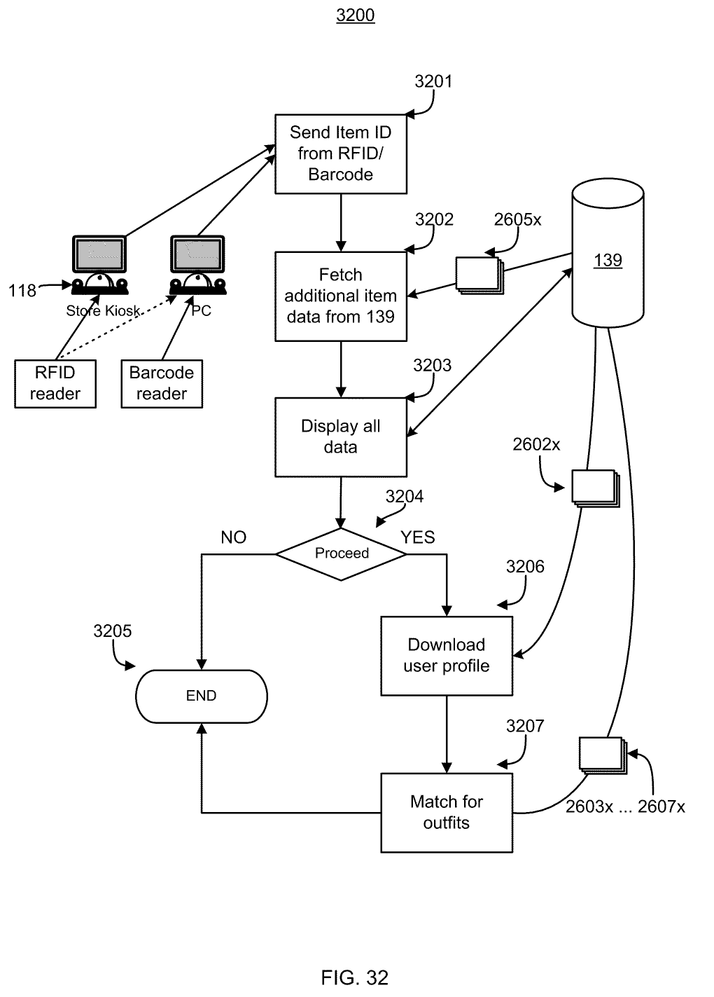

FIGS. 25-32 shows a match system 2500 and processes used to enable a shopping process, each described in greater detail in Wannier IV.

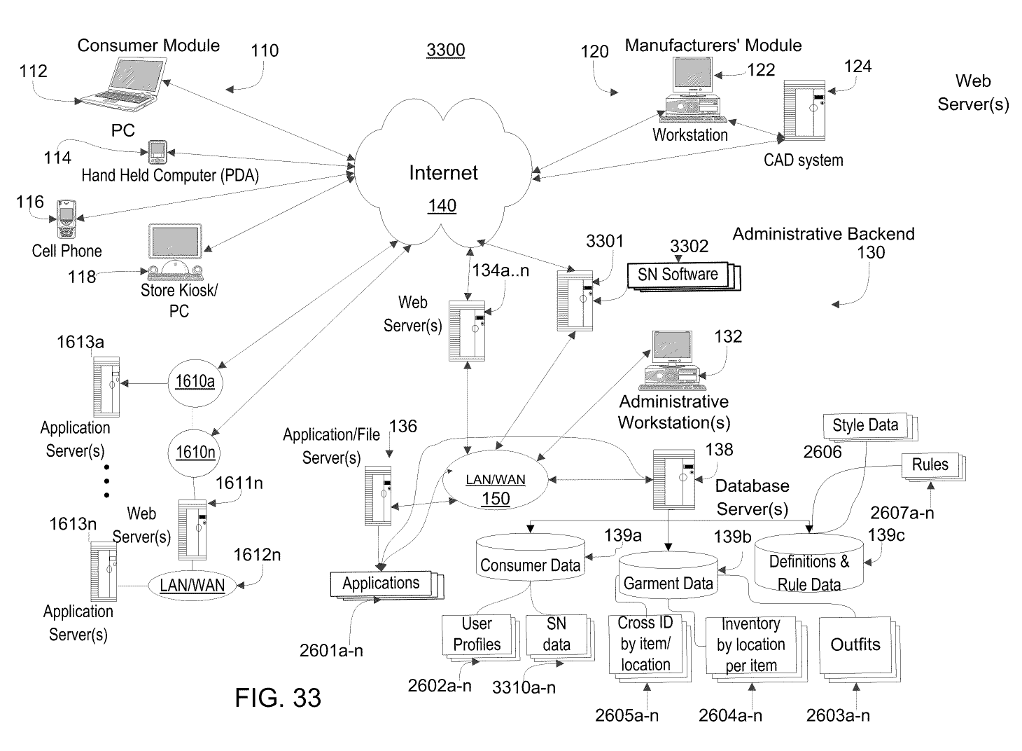

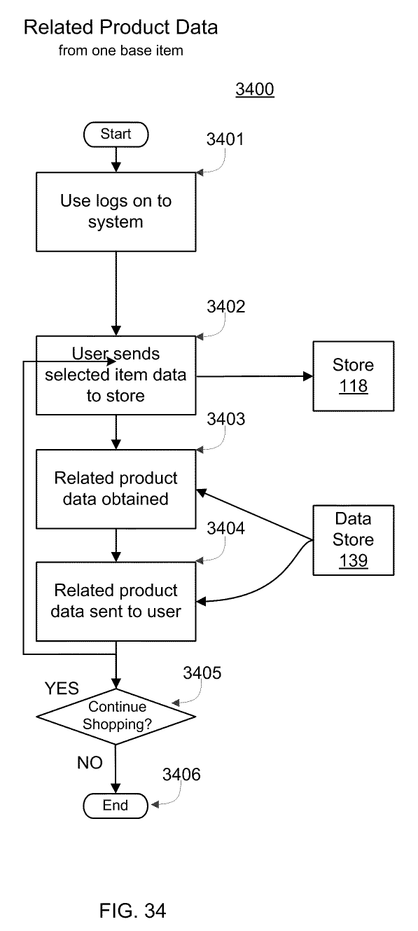

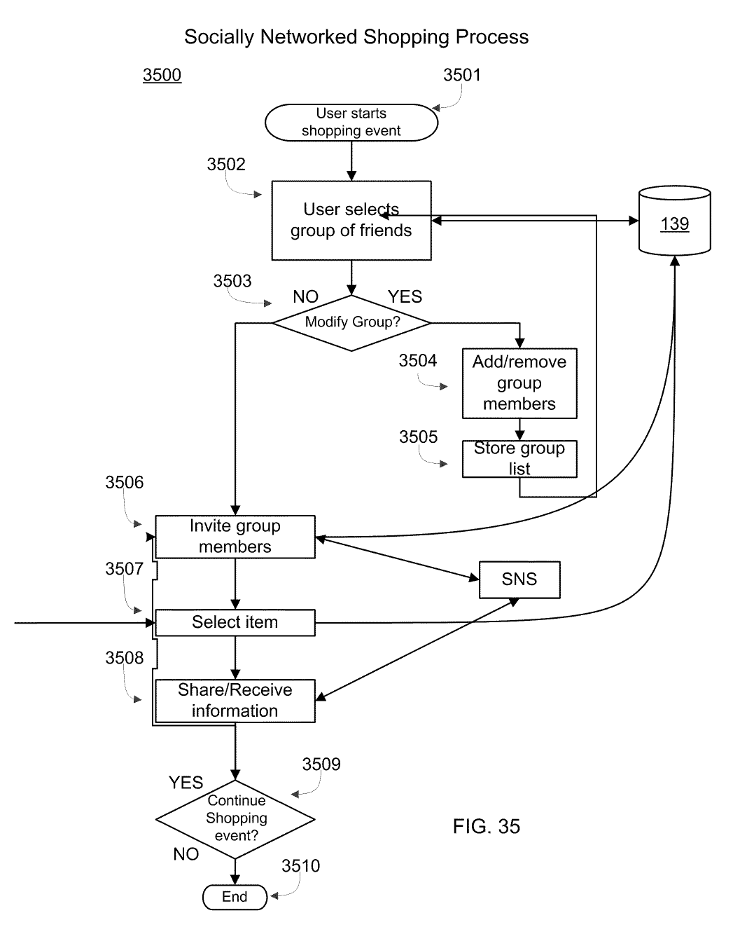

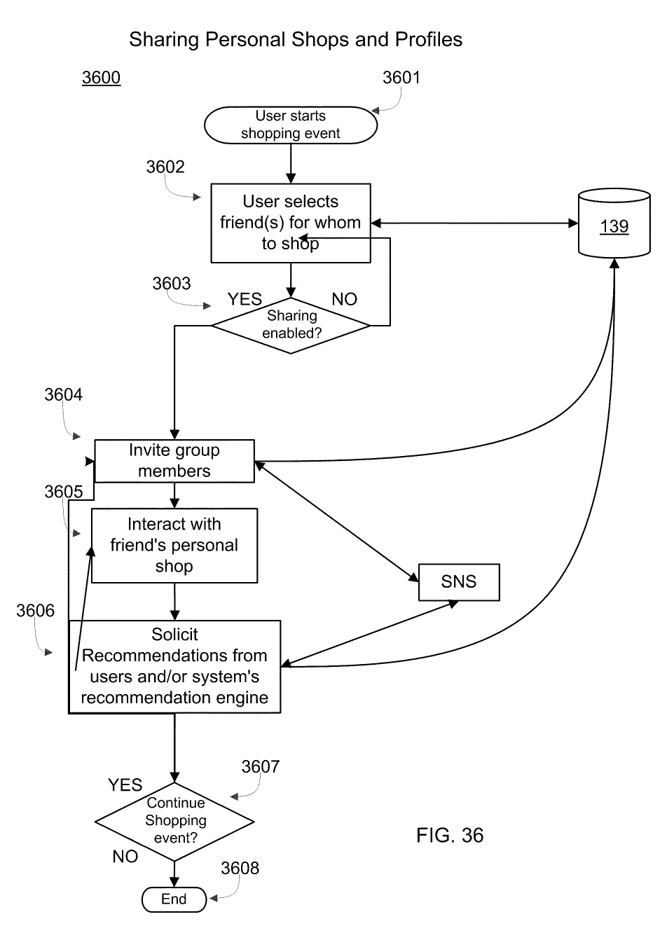

FIGS. 33-36 show a socially networked shopping system 3300 that is described in greater detail in Wannier V.

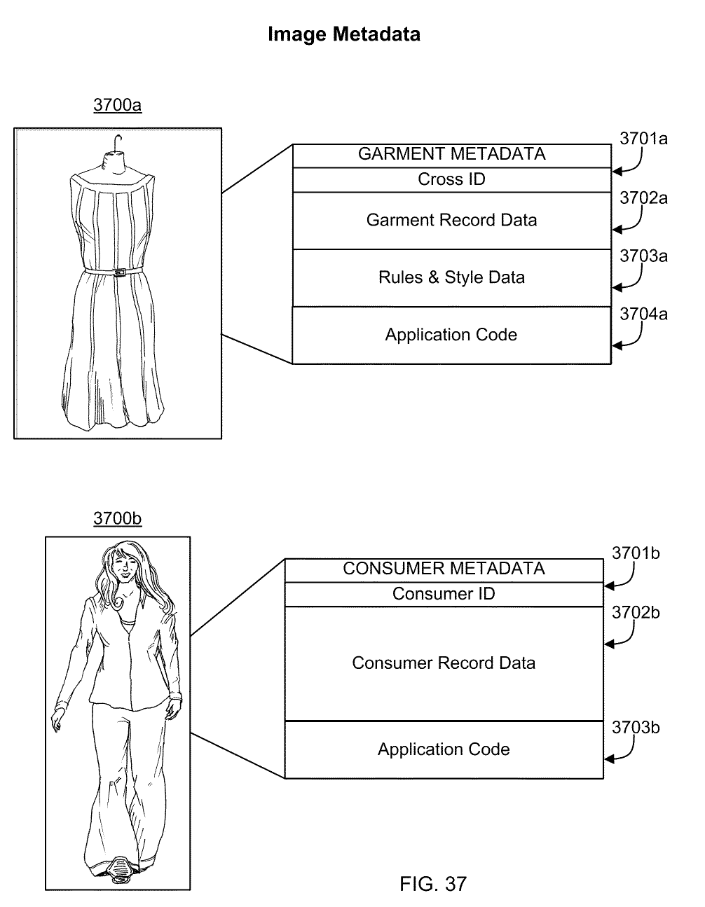

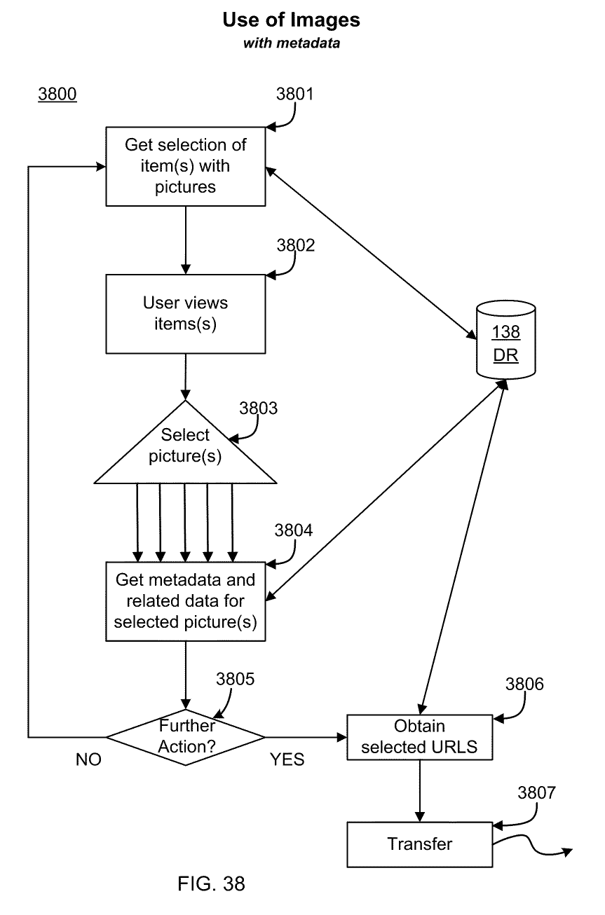

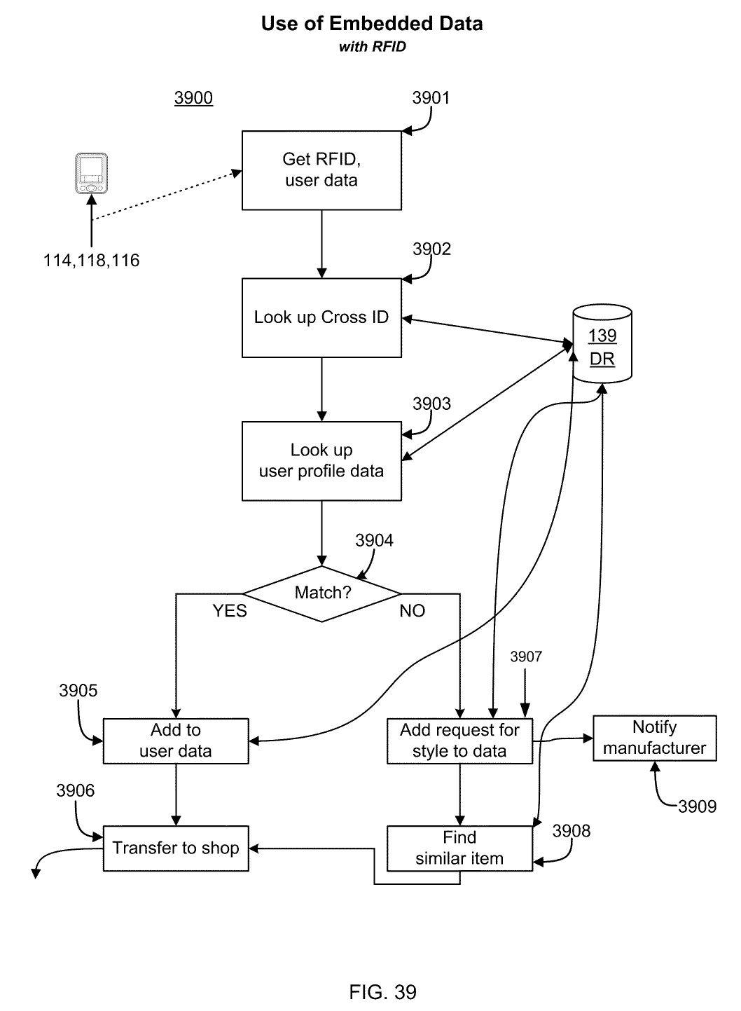

FIGS. 37-39 show a system and method for integrating vendor and buyer information using metadata that is described in greater detail in Wannier VI.

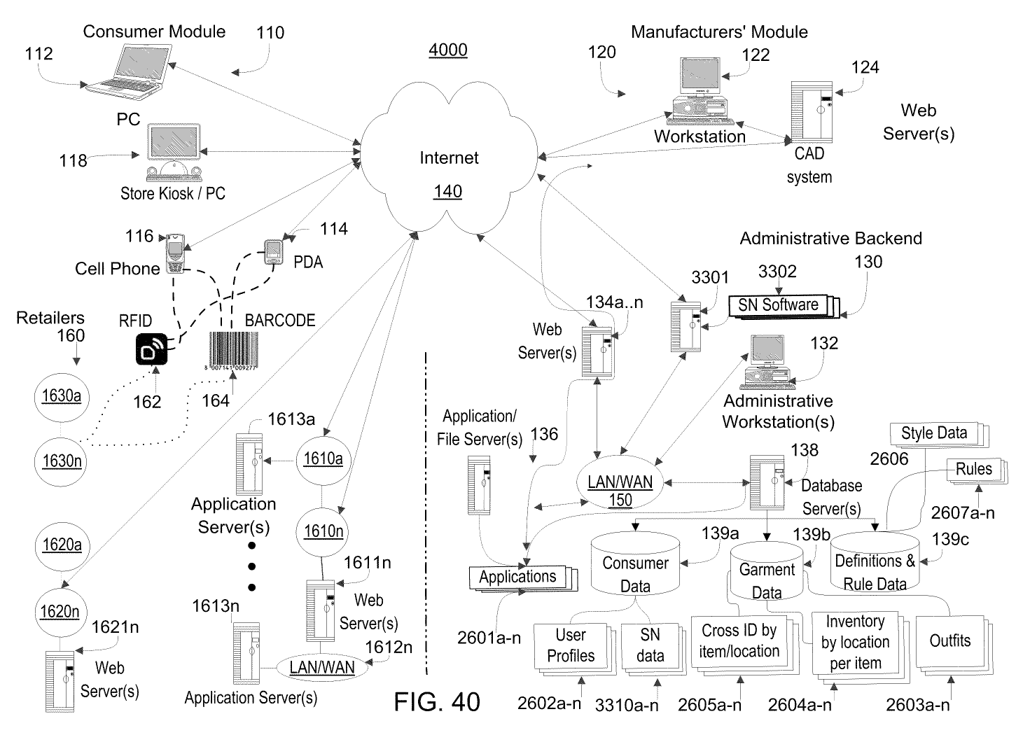

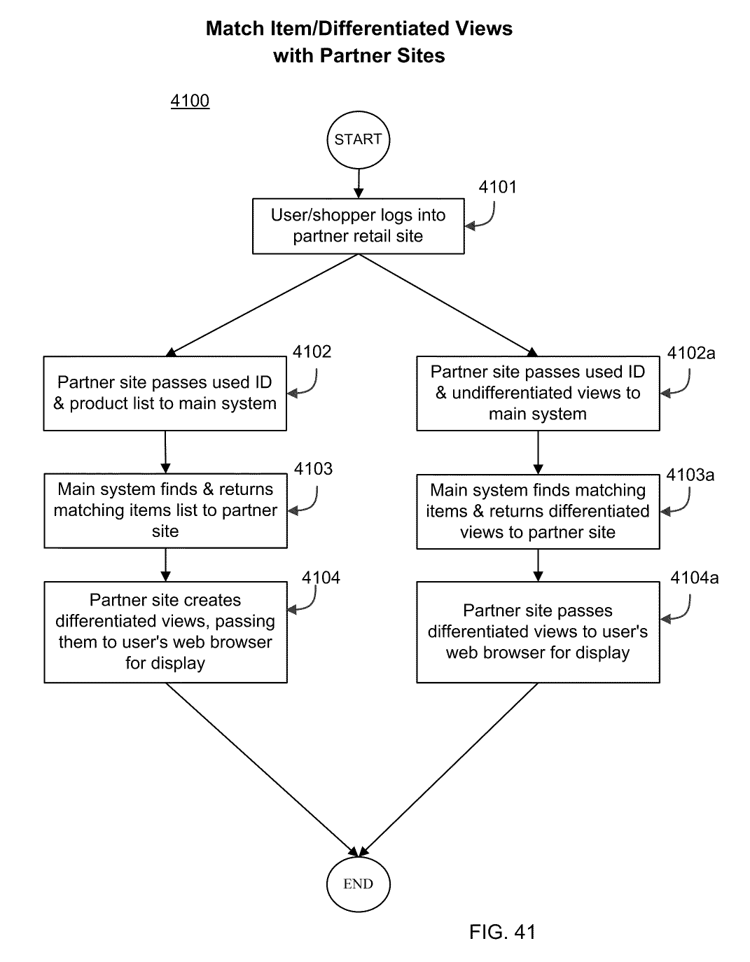

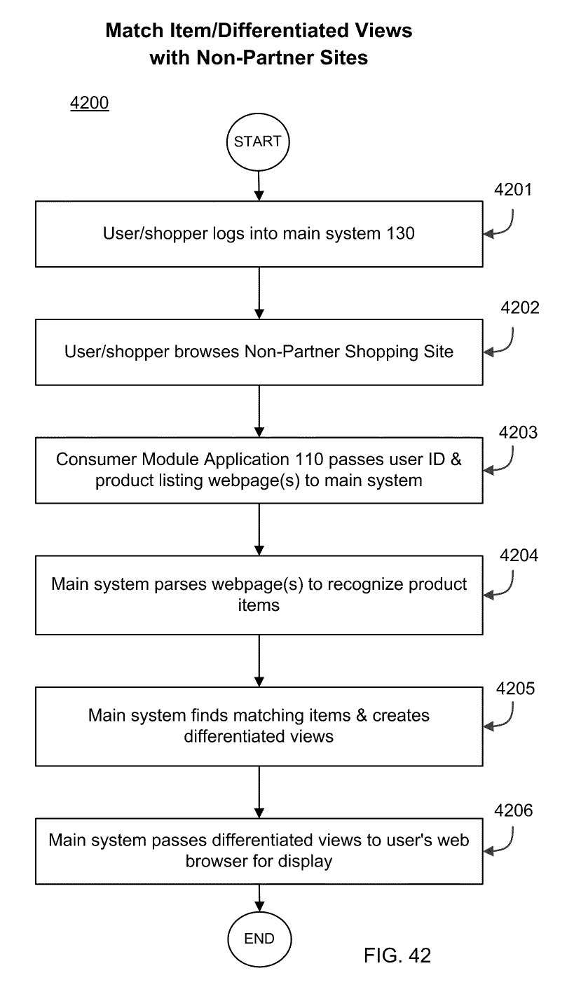

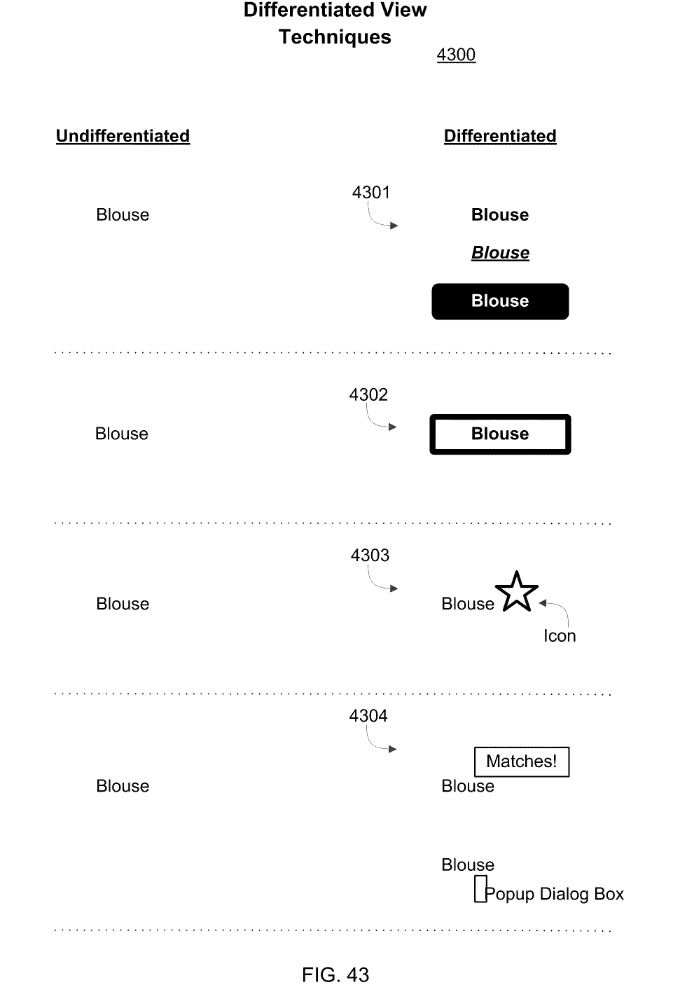

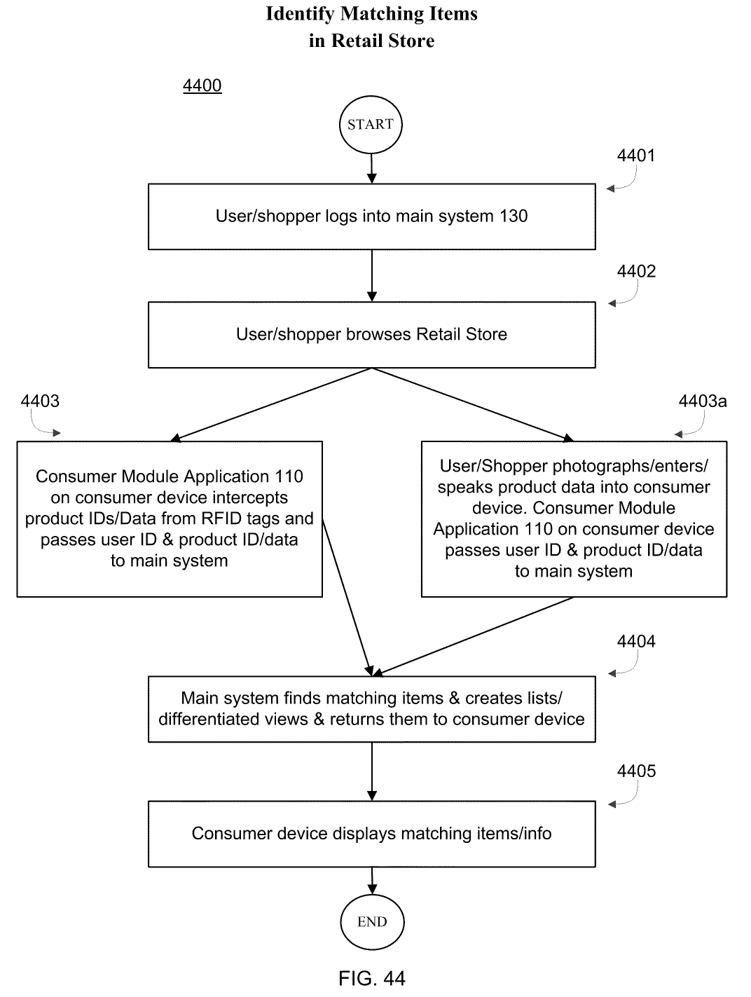

FIGS. 40-44 show a system and method to identify and visually distinguish personally relevant items that is described in greater detail in Wannier VII.

### A Market Processing and Mapping System

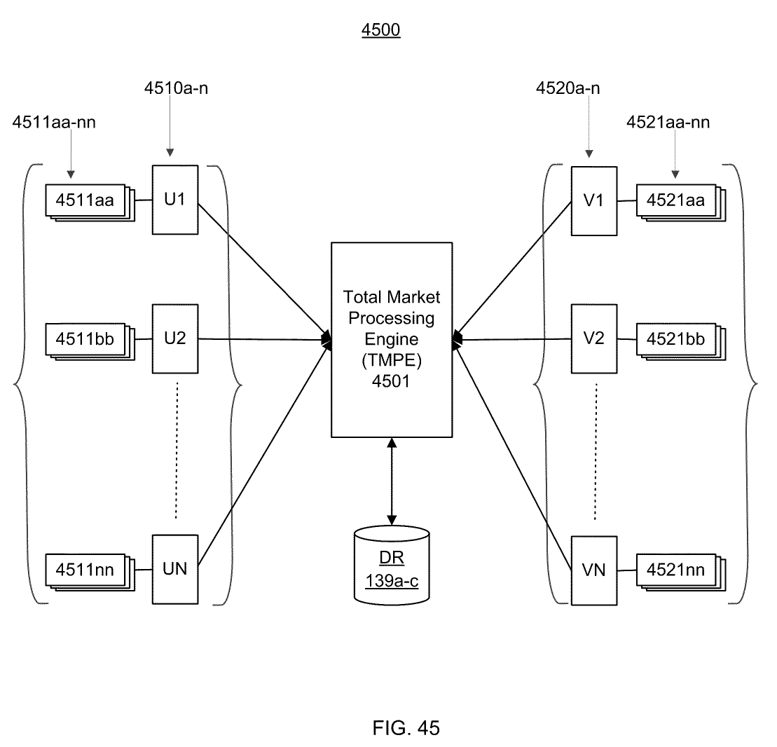

FIG. 45 shows an overview of an exemplary system 4500 according to one embodiment of the present invention. Total market processing engine (“TMPE”) 4501 typically would be implemented in a system such as system 4000, described earlier. In particular, system 4500 comprises a novel view of data organization. In some implementations, this is performed on a dedicated computer system, whereas in other implementations it is implemented in hardware or on shared systems. In any case, it is not practical to perform the necessary operations without using some computing power.

On the left side of FIG. 45 are user systems U1-UN 4510a-n, which can be computers, cell phones, PDAs, netbooks, and/or other computing devices. Each user system U1-UN has a corresponding set of data documenting the user's customer desires, preferences, existing wardrobes, orders, etc., as represented by 4511aa-nn (with one or more such data element per user). Thus, for example, user 4510a has a corresponding data set 4511aa-an; user 4510b has corresponding data set 4511ba-bn set, and so forth. Typically, these data sets could be stored in a data repository, such as consumer DR 139a. Data sets 4511aa-nn may include user profiles 2602a-n and or social networking data 3310a-n. In other cases, for example, data could be copied from these and other sources as a snapshot to a separate database (not shown) for easier, faster manipulation, and to separate loads from normal operations and research with the TMPE.

On the right side of FIG. 45, TMPE 4501 is a similar view of vendors V1-VN 4512a-n and their corresponding product data sets 4521aa-nn. Typically, these data sets could be stored in a data repository, such as garment DR 139b, wherein data sets 4521aa-nn may include garment data sets 2603a-n, 2604a-n, 2605a-n as described earlier. In other cases, for example, data could be copied from these and other sources as a snapshot to a separate database (not shown) for easier, faster manipulation, and to separate loads from normal operations and research with the TMPE. In general, at least some of the data comes from actual measurements of users and/or actual entries or interactions made by the users.

The TMPE allows these data to be pulled together and viewed or organized and analyzed in different ways. For example, using known data mining and clustering techniques, market segments and affinities can be identified and quantified. Resultant segmentation analyses may be stored in a separate database (not shown). Given the broad reach, multiple data sets, unique cross-keying IDs and functionalities available in shopping system 4000, the TMPE can provide more comprehensive pan-industry segmentation than is currently available from incompatible business intelligence solutions silo-ed at individual retailers' and manufacturers' facilities.

Thus, unserved or underserved segments, which represent market opportunities, can be more readily identified and with a finer level of detail than currently possible. Definitions and rules contained in database 139c may be used to make recommendations to designers and manufacturers for the adjustment of styling, sizing, pattern measurements, pricing or other factors in order to best satisfy the newly identified market opportunities.

A market opportunity might be identified by segmenting users and garments in various ways. The different segmenting methods could be expected to result in different opportunity results. For example, suppose that the garments market is segmented by color range and each consumer's personal shop contains at least ten items of each color range. Suppose there is a threshold of four as the indicator of a market opportunity. In that case, no market opportunity would be flagged by the system (although these facts are unlikely to occur in the real world).

Now suppose the garments market is segmented by style into “dressy”, “formal” and “casual” and users are segmented by body type. While there might be a good mix of colors, suppose it turns out that most of the personal shops for consumers with body types “A”, “M” and “P” would only match two or fewer garments that have the style field of their garment record set to “casual” for blouses. In other words, most consumers using the shopping system described herein would not see enough casual blouses if their body type is “A”, “M” or “P”. With the data being as described, the system would flag this as a market opportunity. Of course, the thresholds can be different values for different situations and might involve other variables.

Market segments might include segmenting by geography, consumer age, garment type, fashion style, fashion category, season, designer, color or other fields available for garments and consumers. The differential between existing assortment and ideal assortment can be calculated both at the individual personal shop level and at the market segment level and can be a simple threshold or more complicated.

Using the previously described communications channels available in shopping system consumer module 110, consumers may suggest or request items or modifications from a manufacturer(s). This consumer feedback and the identified market opportunities data are made available to clothing designers, manufacturers and/or vendors again through previously described channels. The TPME allows designers, manufacturers and vendors to respond to consumer feedback by pushing new products or design ideas based on requests from users. Thus product data sets 4521aa-nn may contain data about actual products or they may be product proposals floated to see how consumers and market segments would respond.

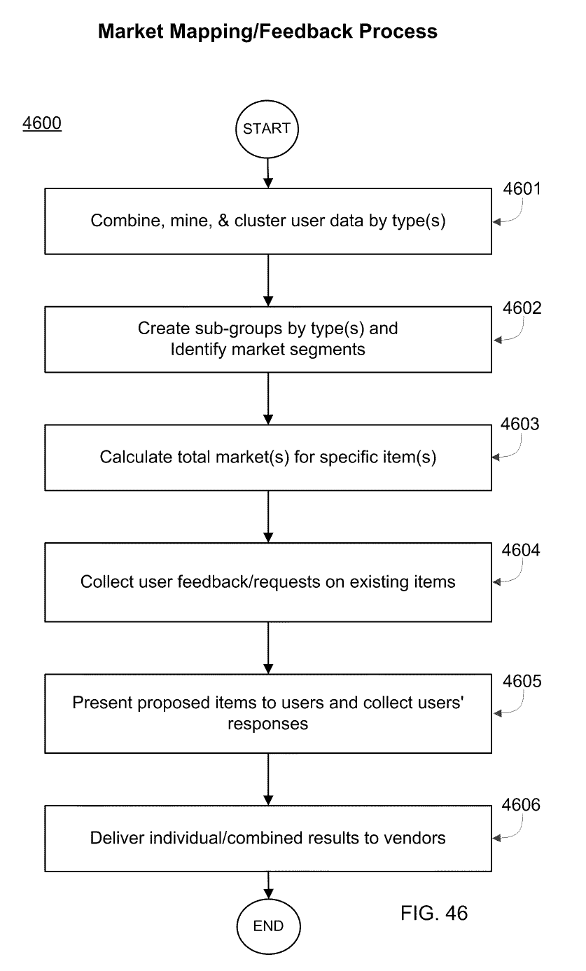

FIG. 46 shows a simplified overview of an exemplary process 4600 for implementation of the system according one embodiment of to the current invention. This process, to be practical, is implemented using suitable computing devices, processors and data storage.

In step 4601, the suitable system calculates, separates, and sorts all the data for users, sizes, preferences, browsing, site usage, shopping, purchase history and demographics for any desired shape(s) to calculate the total available market for each size and style of the specified shape(s). Using well-known data mining techniques, the system may also identify unanticipated clusters for segmentation and sorting purposes. Then, in step 4602, the system organizes the results of the segmentation calculations into sub-groups sorted by type, shape, and style, or other attributes as needed. At this step, it also identifies unserved or underserved segments.

Based on these groupings, in step 4603 the system then calculates the total market for specific item models, as, for example, proposed by vendors. This calculation step can be done in some cases without interacting with the users, or in other cases, as described further below, an actual inquiry can be sent to users to see how they respond to new proposals, this inquiry in some cases based on previously provided requests. In yet other cases, proposals are made to users based on users subscribing to new items, hence showing a genuine interest in those items. Further, in yet other cases, these proposals may be based on user-requested combination proposals, or store fashion preferences, etc.

In some cases, proposals may also be based on event information provided by the user, or based on a friend's recommendation or fellowship by a user (i.e., I would like to get similar proposals like “Annie” chose, but not identical). In yet other cases, proposals may be influenced by the user's already existing personal closet, and sometimes proposals may include items from more than one vendor, in combinations. In step 4604, user response information about desires and demands expressed by users can be collected from the user's computing devices and, in step 4605, the system can send out an inquiry about a specific new idea to users. Thus, rather than producing an item of clothing or an accessory and then seeing whether or not it is successful in stores, a new style can be tested without spending even a fraction of the cost and time to see if there is demand. In step 4606, the combined results are delivered to vendors.

The vendors might pay to participate in the TMPE system, via a fixed price per use, a share of revenue, a share of profit, or other measure of value and/or cost. It is in the interest of participants to minimize the number of interactions with user so as to not annoy users to the point where they feel this system is bothersome and no longer participate.

It is clear that many modifications and variations of this embodiment may be made by one skilled in the art without departing from the spirit of the novel art of this disclosure. In some cases, the system may generate an understanding of the creation, use, and disposition of all products in a market, from manufacturers to end users; while in other cases, the system may allow for a portal connecting designers to an inventory system to allow direct input from designers, such as advice on future trends.

In other cases for example, the system may provide a pre-chosen plurality of products to users in exchange for a regular payment made at specific time intervals, thus allowing subscribing users to receive a coordinated set of products, such as a clothing outfit, on a regular basis. The system may also personalize services hosted on a first site but accessible on a second site, such as a store embedded within a store, thus allowing users to customize their personal experience regardless of the host of the services they are receiving, such as a preferred sort order at multiple sites. Further, the system may recommend products, optionally outfits, for a specific event as detailed by the user, and it may also aid users wishing to find products that go well with each other, based on actions others may have made in the past that relate to the product or products of interest, thus providing a tool that returns other products that have been combined with the first product by other users.

In yet other cases, the system may continually readjust the products it markets to users based on new information that becomes available, such as a purchase by the user, and it may increase the range and breadth of products that are available to a user beyond immediately available goods for order by allowing indications of interest to be captured for future, potential or custom-made products. Additionally, the system may complete a look based on offering complementary garments to exemplary garments selected from a user's personal closet—an inventory of owned garments, and it may also complete a look based on offering complementary garments to the exemplary garments where the complementary garments may come from a variety of vendors.

These modifications and variations do not depart from the broader spirit and scope of the invention, and the examples cited here are to be regarded in an illustrative rather than a restrictive sense. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. A computer system for analyzing consumer data, including at least personal information representing the consumer, in forming personal shop data sets representing a filtered view of a garment database of garments and accessories offered for sale, wherein the personal shop data set for a consumer is filtered according to one or more of consumer preference, consumer measurements, or consumer body shape, as such filters are represented in a computer-readable consumer record, the computer system comprising:
storage for a plurality of segment descriptions, wherein a segment description is electronically-stored data and/or rules representing a segmentation of items in the garment database or consumers based on consumer record details;
logic for determining a personal shop data set for each of a plurality of consumers;
logic for segmenting each of the personal shop data sets according to the plurality of segment descriptions;
logic for determining a differential between a number of items in a segment of a personal shop relative to a predetermined ideal value or range of values; and
logic for collecting a data set of market opportunity flags, wherein a market opportunity flag is associated with a segment that the logic for determining determines is underrepresented, relative to the ideal, for one or more personal shop data set

2. The computer system of claim 1, wherein the segments represent garment segmentation and include one or more of garment type, fashion style, fashion category, designer, and/or color.

3. The computer system of claim 1, wherein the segments represent consumer segmentation and include segmenting by geography, consumer age, and/or consumer measurements.

4. The computer system of claim 1, wherein the segments represent segmentation that is consumer and garment independent and includes season, external demand inputs and external market measurements.

5. The computer system of claim 1, wherein the differential is a differential calculated both on a consumer by consumer level and by a market segment-by-segment level.

6. The computer system of claim 1, further comprising logic for outputting messages to vendor computer systems to indicate particular market opportunities.

7. The computer system of claim 1, wherein logic for determining the differential includes inputs for one or more of consumer click activity, consumer profile, consumer spending patterns, consumer measurements and/or garment details.

8. The computer system of claim 1, further comprising:
storage for consumer browsing behavior data;
logic for determining distillations of a consumer's browsing behavior, using the consumer browsing behavior data;
logic for converting distillations into interest records, wherein an interest record indicates a correspondence between a consumer and interest in a garment and/or a segment of garments represented in the garment database; and
wherein the logic for determining the differential takes as an input the distilled interest records.

9. The computer system of claim 1, wherein logic for determining the differential includes logic for determining whether garment changes would alter the differential and further comprising an output for generating a report of market opportunities that would arise from changes to garments.

10. The computer system of claim 1, further comprising:
a communications system that distributes advertisements to consumers;
tracking logic for tracking consumer response to advertisements; and
logic for comparing consumer interest in advertisements to detect differentials representing consumer interest in advertisements for garments that are not represented in the consumer's personal shop, thereby generating indications of a market opportunity.
